(19) United States
(12) Patent Application Publication
(10) Pub. No.: US 2025/0190105 A1
(43) Pub. Date: Jun. 12, 2025

(54) Methods and systems for a user-adaptive virtual keyboard

(71) Applicants: Wei LI, Markham (CA); Che YAN, Markham (CA); Shuping LU, Markham (CA); Soheil KIANZAD, Markham (CA)

(72) Inventors: Wei LI, Markham (CA); Che YAN, Markham (CA); Shuping LU, Markham (CA); Soheil KIANZAD, Markham (CA)

(21) Appl. No.: 18/537,027

(22) Filed: Dec. 12, 2023

(51) Int. Cl. G06F 3/04886

(52) U.S. Cl. CPC G06F 3/04886; G06F 2203/04803

(57) ABSTRACT

There are provided methods and systems for a user-adaptive virtual keyboard comprising a plurality of virtual adaptive keys. In examples, the systems, methods, and processor-readable media can be applied to dynamically configure a user interface of the user-adaptive virtual keyboard, to adapt to a user's needs and preferences, while the user is performing a typing action. In response to detecting a user touch input, the user-adaptive virtual keyboard may generate an updated virtual keyboard UI, by dynamically adjusting one or more properties of the plurality of virtual adaptive keys. The disclosed methods and systems may enable improved user interaction with a virtual keyboard on an electronic device, for example, while a user is performing blind typing actions.

### FIELD

The present disclosure relates to the field of human-computer interaction, in particular, methods and systems for interacting with virtual keyboards.

### BACKGROUND

In recent years, the advancement of technology has led to an increase in the touch area on the C-side of laptops (where C-side refers to the side of the laptop that traditionally housed the keyboard) and the emergence of dual-screen devices. These dual-screen laptops offer users the flexibility to switch between display and input modes, providing for a larger space for both input and display. As a result, there has been interest in developing graphical user interface (GUI) interaction designs that can accommodate dual-screen interactions.

Within this context, virtual keyboard input has increased in importance. Earlier virtual keyboard designs typically aimed to simulate the physical keyboard on a touch screen, enabling users to input text on devices like tablets and smartphones. These designs typically also offered additional features such as language switching, numeric keypads, symbol keypads, and emojis.

With the advent of foldable computers and their larger display and input areas, there is an opportunity for greater virtual keyboard functionality to meet the unique requirements of foldable devices.

Accordingly, improvements in user interaction with virtual keyboards is desired.

### SUMMARY

In various examples, the present disclosure describes methods and systems for improved user interaction with virtual keyboards on electronic devices using a user-adaptive virtual keyboard comprising a plurality of virtual adaptive keys. By “user-adaptive”, it is meant that the user-adaptive virtual keyboard is configured to dynamically adjust a keyboard layout to adapt to a user's needs and/or preferences, while the user is performing a typing action. In response to detecting a user touch input, the user-adaptive virtual keyboard may generate a custom virtual keyboard UI, by dynamically adjusting one or more properties of the plurality of virtual adaptive keys. Examples of the disclosed methods and systems may enable improved user interaction with a virtual keyboard on an electronic device, for example, while a user is performing blind typing (also referred to as touch typing) actions.

In various examples, the present disclosure provides the technical effect that a virtual keyboard user interface (UI), that facilitates blind typing interactions, is output to a display without requiring tactile feedback commonly provided by physical keyboards. For example, physical keyboards have a fixed layout and tactile features (e.g., keycaps with defined edges, keys that move when pressed, raised surfaces on anchor keys “F” and “J”) for assisting a user to orient their hands to a home row of keys without looking at the keyboard. In this regard, a physical keyboard has tactile features that allow a user to adjust their hand position and locate the home row keys, thereby causing the user to accommodate the limitations of the physical keyboard. In contrast, the user-adaptive virtual keyboard, as disclosed herein, is configured to automatically configure a virtual keyboard layout to accommodate a user's hands (e.g., hand position, hand size, typing preferences, etc.). The virtual keyboard may dynamically adjust a respective key size, key pitch, key gap and/or aspect ratio, among other properties, of a plurality of adaptive keys, based on a detected touch input or an existing user hand profile, to generate the custom keyboard layout. In this regard, the virtual keyboard may be user-adaptive.

In examples, the user-adaptive virtual keyboard may provide advantages for blind typing on a virtual keyboard, by leveraging a user's existing muscle memory associated with typing actions and familiarity with standard keyboard layouts for more intuitive blind typing on a virtual keyboard.

In examples, the user-adaptive virtual keyboard may also provide advantages for blind typing on a virtual keyboard by distinguishing between intentional touch inputs and unintentional touches. Incorrectly detecting unintentional touches can lead to false positives (that is, erroneous entries due to unintentional touches being interpreted as key inputs) can interrupt the flow of touch typing, for example, causing the user to pause and delete erroneous entries. In this regard, unintentional touches may lead to user fatigue, typing errors, and frustration while interacting with a virtual keyboard. By helping to avoid such false positives, examples of the present disclosure may help to reduce the amount of user input and/or processing power required to process (and subsequently undo) the erroneous entries. This may provide a more efficient and/or more effective virtual keyboard.

In examples, the user-adaptive virtual keyboard may also provide advantages for typing on small screens having small keys, for example by learning patterns or preferences in a user's typing style. In this regard, the user-adaptive virtual keyboard may map keyboard inputs to touch inputs for a specific user more accurately.

In an example aspect, the present disclosure describes a computer-implemented method including: detecting a touch input on a touch sensitive display; generating a virtual keyboard user interface (UI) based on the touch input, the virtual keyboard UI comprising a plurality of virtual objects arranged in a user-adaptive layout based on the touch input; and outputting the virtual keyboard UI to be displayed on the touch sensitive display, according to the user-adaptive layout.

In an example of the preceding example aspect of the method, the plurality of virtual objects may include a plurality of adaptive virtual keys, each of the plurality of adaptive virtual keys having a respective one or more properties for dynamically configuring the user-adaptive layout, and generating the virtual keyboard UI may include: adjusting the respective one or more properties of each of the plurality of adaptive virtual keys, based on the touch input.

In an example of the preceding example aspect of the method, the one or more properties may include at least one of: key size; key pitch; key gap; or key aspect ratio.

In an example of some of the preceding example aspects of the method, the plurality of virtual objects may include a first panel of virtual keys and a second panel of virtual keys, where each of the plurality of virtual adaptive keys may be configured in the user-adaptive layout to be adjacent to one or both of the first panel of virtual keys and the second panel of virtual keys, and where outputting the virtual keyboard UI to be displayed may include: outputting the first panel of virtual keys, the second panel of virtual keys and the plurality of adaptive keys to be displayed, according to the user-adaptive layout.

In an example of any of the preceding example aspects of the method, detecting the touch input may include: detecting touch input at locations representative of home row finger positions defined in the virtual keyboard UI.

In an example of any of the preceding example aspects of the method, the method may include: prior to detecting the touch input: detecting a virtual keyboard launch gesture in proximity to the touch sensitive display; detecting a hand position in proximity to the touch sensitive display, based on the virtual keyboard launch gesture; and configuring a preview of the virtual keyboard UI to be displayed on the touch sensitive display, based on the hand position.

In some example aspects, the present disclosure describes a computer-implemented method including: performing a virtual keyboard calibration by: detecting touch input on a touch sensitive display, the touch input being detected as sensor data representative of a placement of a palm and fingers of a hand on the touch sensitive display; and obtaining one or more measurements of the hand, based on the sensor data. The method also includes: generating a virtual keyboard user interface (UI) comprising a plurality of virtual objects arranged in a user-adaptive layout based on the one or more measurements of the hand obtained by performing the virtual keyboard calibration; and outputting the virtual keyboard UI to be displayed on the touch sensitive display, according to the user-adaptive layout.

In an example of the preceding example aspect of the method, a user hand profile may be generated based on the one or more measurements of the hand.

In an example of the preceding example aspect of the method, the user hand profile may be stored and the user-adaptive layout of the virtual keyboard UI may be stored in association with the user hand profile.

In an example of the preceding example aspect of the method, generating the virtual keyboard UI may include determining that the user hand profile matches an existing stored user hand profile, and retrieving the stored user-adaptive layout associated with the stored user hand profile to use for the generating the virtual keyboard UI.

In an example of any of the preceding example aspects of the method, the method may include: prior to performing the virtual keyboard calibration, detecting a virtual keyboard launch gesture in proximity to the touch sensitive display; and performing the virtual keyboard calibration responsive to detecting the virtual keyboard launch gesture.

In an example of any of the preceding example aspects of the method, the plurality of virtual objects may include a plurality of adaptive virtual keys, each of the plurality of adaptive virtual keys having a respective one or more properties for dynamically configuring the user-adaptive layout, and generating the virtual keyboard UI may include: adjusting the respective one or more properties of each of the plurality of adaptive virtual keys, based on the one or more hand measurements.

In an example of the preceding example aspect of the method, at least one property of each of the plurality of adaptive virtual keys may be at least one of: key size; key pitch; key gap; or key aspect ratio.

In some example aspects, the present disclosure describes a computer-implemented method including: detecting a touch input on a touch sensitive display, the touch input representing home row finger positions defined for a virtual keyboard user interface (UI); outputting the virtual keyboard UI to be displayed on the touch sensitive display, the virtual keyboard UI being displayed at a location on the touch sensitive display corresponding to the touch input representing the home row finger positions; in response to detecting touch input representing movement of the home row finger positions away from the edge of the touch sensitive display, move the virtual keyboard UI to increase a margin between the virtual keyboard UI and an edge of the touch sensitive display; wherein a virtual trackpad is displayable in the margin between the virtual keyboard UI and the edge of the touch sensitive display.

In an example of the preceding example aspect of the method, a size of the virtual trackpad may increase as the margin between the virtual keyboard UI and the edge of the touch sensitive display increases, and the size of the virtual trackpad may decrease as the margin between the virtual keyboard UI and the edge of the touch sensitive display decreases.

In an example of any of the preceding example aspects of the method, the virtual trackpad may be displayed in the margin between the virtual keyboard UI and the edge of the touch sensitive display in response to the virtual keyboard UI being moved a first threshold distance from the edge of the touch sensitive display.

In an example of the preceding example aspect of the method, the virtual trackpad may be displayed in the margin between the virtual keyboard UI and the edge of the touch sensitive display at a maximum trackpad size in response to the virtual keyboard UI being moved a second threshold distance, greater than the first threshold distance, from the edge of the touch sensitive display.

In an example of any of the preceding example aspects of the method, the method may include: detecting a touch input representing selection of a trackpad toggle button displayed on the touch sensitive display; responsive to selection of the trackpad toggle button, moving the virtual keyboard UI to increase the margin between the virtual keyboard UI and the edge of the touch sensitive display to accommodate display of the virtual trackpad; and displaying the virtual trackpad in the margin between the virtual keyboard UI and the edge of the touch sensitive display.

In an example of the preceding example aspect of the method, responsive to selection of the trackpad toggle button, the virtual keyboard UI may be moved to increase the margin between the virtual keyboard UI and the edge of the touch sensitive display to accommodate display of the virtual trackpad at a maximum trackpad size.

In an example of any of the preceding example aspects of the method, the method may include: while the virtual trackpad is displayed, detecting a touch input representing another selection of the trackpad toggle button; responsive to selection of the trackpad toggle button, moving the virtual keyboard UI to decrease the margin between the virtual keyboard UI and the edge of the touch sensitive display; and hiding the virtual trackpad from being displayed.

In some example aspects, the present disclosure describes a computing system including a processor configured to execute instructions to cause the computing system to perform any of the preceding example aspects of the method.

In some example aspects, the present disclosure describes a non-transitory computer readable medium storing instructions thereon. The instructions, when executed by a processor, cause the processor to perform any of the preceding example aspects of the method.

### BRIEF DESCRIPTION OF THE DRAWINGS

Reference will now be made, by way of example, to the accompanying drawings which show example embodiments of the present application, and in which:

FIG. 1 is a block diagram illustrating an example computing system which may be used to implement examples of the present disclosure;

FIG. 2 is an exploded view showing an example configuration of modules suitable for implementing a user-adaptive virtual keyboard, in accordance with examples of the present disclosure;

FIGS. 3A-C show example configurations of a user-adaptive virtual keyboard UI, in accordance with examples of the present disclosure;

FIG. 4 is a flowchart illustrating an example method for dynamically adjusting one or more adaptive keys of the user-adaptive virtual keyboard, in accordance with examples of the present disclosure;

FIG. 5 shows a block diagram of an example software architecture for implementing the user-adaptive virtual keyboard, in accordance with examples of the present disclosure;

FIG. 6 illustrates an example embodiment of a user-adaptive virtual keyboard, in accordance with examples of the present disclosure;

FIGS. 7A-C show example configurations of a motion space layer, in accordance with examples of the present disclosure;

FIG. 8 is a flowchart illustrating an example method for dynamically adjusting a motion space layer of the user-adaptive virtual keyboard, in accordance with examples of the present disclosure;

FIGS. 9A-B show example configurations of a functional key motion space, in accordance with examples of the present disclosure;

FIG. 10 is a flowchart illustrating an example method for mapping a motion space to functional keys in the user-adaptive virtual keyboard, in accordance with examples of the present disclosure;

FIG. 11 illustrates an example onboarding session for measuring a user's hands, in accordance with examples of the present disclosure;

FIG. 12 is a flowchart illustrating an example method for generating the user-adaptive virtual keyboard based on a user hand profile, in accordance with examples of the present disclosure;

FIGS. 13A-D show example configurations of a user-adaptive virtual keyboard UI with respect to a capacitive finger image, in accordance with examples of the present disclosure;

FIG. 14 is a flowchart illustrating an example method for adjusting a sensitivity threshold of the sensing module of the user-adaptive virtual keyboard, in accordance with examples of the present disclosure;

FIGS. 15A-C show example configurations of a user-adaptive virtual keyboard UI with respect to an adaptive keyboard home row safe zone, in accordance with examples of the present disclosure;

FIG. 16 is a flowchart illustrating an example method for generating notifications to users regarding the adaptive keyboard home row safe zone, in accordance with examples of the present disclosure;

FIGS. 17A-C illustrate an example virtual keyboard preview feature of the user-adaptive virtual keyboard, in accordance with examples of the present disclosure;

FIG. 18 is a flowchart illustrating an example method for generating a preview of the user-adaptive virtual keyboard via a hover gesture, in accordance with examples of the present disclosure;

FIGS. 19A-D illustrate an example virtual keyboard with dynamic display of a virtual trackpad, in accordance with examples of the present disclosure

FIG. 19E is a flowchart illustrating an example method for a dynamic trackpad, in accordance with examples of the present disclosure; and

FIG. 20 is a flowchart illustrating an example method for generating a user-adaptive virtual keyboard UI for output to a display, in accordance with examples of the present disclosure.

Similar reference numerals may have been used in different figures to denote similar components.

### DETAILED DESCRIPTION

The following describes example technical solutions of this disclosure with reference to accompanying drawings. Similar reference numerals may have been used in different figures to denote similar components.

To assist in understanding the present disclosure, some existing techniques for interacting with virtual keyboards are discussed. In the present disclosure a “virtual keyboard” refers to a set of soft button, typically displayed on a touch sensitive display, that allows for the input of characters without using physical keys. Typically, a virtual keyboard is displayed in a way that mimics a physical keyboard, for example using the QWERTY layout. As previously mentioned, a challenge design of virtual keyboards is the lack of tactile feedback, since there are no physical keys.

An existing approach to address the challenges of tactile feedback and hand drifting during blind typing on a large touch screen is the TOAST method, an eyes-free keyboard technique. An example of the TOAST method for interacting with a virtual keyboard is described in: Shi, Weinan, et al., “TOAST: Ten-finger eyes-free typing on touchable surfaces”, Proceedings of the ACM on Interactive, Mobile, Wearable and Ubiquitous Technologies 2.1 (2018): 1-23, the entirety of which is hereby incorporated by reference. Based on typing data collected, Weinan, et al. proposed that touch screen keys for blind touch typing need to be larger, and users tend to shift their hands towards the upper right corner, resulting in a curved keyboard layout. A Markov-Bayesian Language model was used to decode users' keystrokes, and using dynamic model parameter adaptation, participants achieved a text entry speed of 41.4 words per minute (WPM) with high accuracy and a natural typing experience.

Another existing approach to address challenges associated with blind typing is the “TypeBoard,” method, including the integration of a pressure-sensitive keyboard to mitigate accidental touches during blind touch typing. An example of the “TypeBoard” method for interacting with a virtual keyboard is described in: Gu, Yizheng, et al., “TypeBoard: Identifying Unintentional Touch on Pressure-Sensitive Touchscreen Keyboards”, The 34th Annual ACM Symposium on User Interface Software and Technology, 2021, the entirety of which is hereby incorporated by reference. Since unintentional touches on a virtual keyboard during blind typing can lead to user fatigue, errors, and disruption in touch typing on touch screen devices, the touch sensitivity of a touch sensitive keyboard can detect the force applied by the user's fingers, for assisting in the differentiation of intentional input from accidental touches and improving the typing experience.

Another existing approach to address challenges associated with blind typing is the “Restype” method, including the integration of a pressure-sensitive 3-state keyboard for touch typing on tablet devices. An example of the “Restype” method for interacting with a virtual keyboard is described in: Li, Zhuojun, et al., “ResType: Invisible and Adaptive Tablet Keyboard Leveraging Resting Fingers”, Proceedings of the 2023 CHI Conference on Human Factors in Computing Systems, 2023, the entirety of which is hereby incorporated by reference. As traditional tablet keyboards require visual attention to locate keys, making touch typing inefficient, the incorporation of a three-state touch surface with unintentional touch prevention may enable users to rest their hands on the keyboard, for example, by assessing resting finger patterns and mitigating the need for visual attention during typing.

Another existing approach to address challenges associated with blind typing is described in: Findlater, Leah, and Jacob Wobbrock, “Personalized input: improving ten-finger touchscreen typing through automatic adaptation”, Proceedings of the SIGCHI Conference on Human Factors in Computing Systems, 2012, the entirety of which is hereby incorporated by reference. Findlater and Wobbrock evaluated personalized keyboard interfaces having adaptive key-press classification models, for an improved touch screen typing experience.

A common drawback to all of the above mentioned approaches is low typing efficiency when using a virtual keyboard. Low typing efficiency may be attributed to four primary challenges. Firstly, the inability of a user to rest their hands on the virtual keyboard, as is commonly done on a physical keyboard, introduces fatigue among users. The absence of a physical surface for hand support hampers long typing sessions and reduces comfort. Secondly, virtual keyboards lack tactile feedback, making it challenging for users to anchor their hands to the home row keys, which is crucial for touch typing. The absence of physical keys and the resulting lack of feedback hinder users' ability to maintain a steady hand position while typing. Thirdly, blind typing becomes more difficult on virtual keyboards as there are no tactile hints, such as key edges, to assist users in finding the keys without looking at the keyboard. The absence of these tactile cues disrupts the muscle memory and reliance on touch for efficient typing. Lastly, the one-size-fits-all approach of virtual keyboards overlooks the natural variations in hand sizes. This limitation poses challenges for users with small or large hands, as the fixed size of virtual keyboards may not be optimal for their hand proportions. This disparity in fit further decreases typing comfort and accuracy. Collectively, these issues hinder the typing efficiency on virtual keyboards, affecting user comfort, speed, and accuracy. Overcoming these challenges would help to enhance the usability and effectiveness of virtual keyboards, thus improving the overall typing experience for users of different hand sizes and typing technique. Although virtual digital keyboards lack tactile feedback, they may be configured to offer flexible display forms, diverse input modes and/or more personalized settings, as well as software correction and completion functions, which may result in improved input efficiency.

In some embodiments, the present disclosure describes examples that address some or all of the above drawbacks of existing techniques for interacting with virtual keyboards.

To assist in understanding the present disclosure, the following describes some relevant terminology that may be related to examples disclosed herein.

In the present disclosure, “blind typing” (also referred to as “touch typing”) can mean: A method of typing on a physical or virtual keyboard where a user's gaze is focused away from the keys, for example, toward a display, while typing is performed by a user (e.g., typing without looking directly at the keys). In examples, blind typing benefits from tactile feedback, for example, tactile indicators are commonly placed on a physical keyboard to anchor a user's hands to a home row finger position for the purpose of blind typing.

In the present disclosure, “home row” or “home row keys” can mean: A row of keys on a physical or virtual keyboard representing a starting or anchor position for a user prior to engaging in blind typing. For example, on a typical QWERTY configured keyboard, the home row would represent the row of keys corresponding to letters or characters “A, S, D, F” for the left hand and “J, K, L, :” for the right hand, where anchor keys include the “F” key and the “J” key.

In the present disclosure, “key pitch” can mean: a distance measured from the center point of adjacent keys on a physical or virtual keyboard. A common key pitch used for standard physical keyboards is 19 mm, however other dimensions may be used.

In the present disclosure, “key gap” can mean: a distance measured between the edges of adjacent keys on a physical or virtual keyboard.

In the present disclosure, “adaptive keys” or “elastic keys” can mean: virtual keys on a virtual keyboard having properties which can be dynamically adjusted to cause a change in the layout of the virtual keyboard. In examples, adaptive keys may automatically adjust one or more properties according to a user hand profile, or in response to a user input, while a user interacts with a user-adaptive virtual keyboard.

In the present disclosure, a “touch event” or a “touch down event” can mean: a single touch input that is detected on a touch sensitive surface, for example, when one finger of a user's hand contacts the touch sensitive surface. In examples, a touch input resulting from a typing action on a touch sensitive surface may include multiple touch events. In examples, a touch event may be intentional, for example, when the user is typing, or a touch event may be unintentional, for example, when a user is simply resting their fingers on the touch sensitive surface.

In the present disclosure, a “motion space” refers to the Gaussian distribution about each virtual key in a virtual keyboard that represents the probability of a touch event being detected in a region about the virtual key when the virtual key is the intended target of the touch event. The motion space provides a mapping between a contact location on a touch sensitive surface and a corresponding key.

Other terms used in the present disclosure may be introduced and defined in the following description.

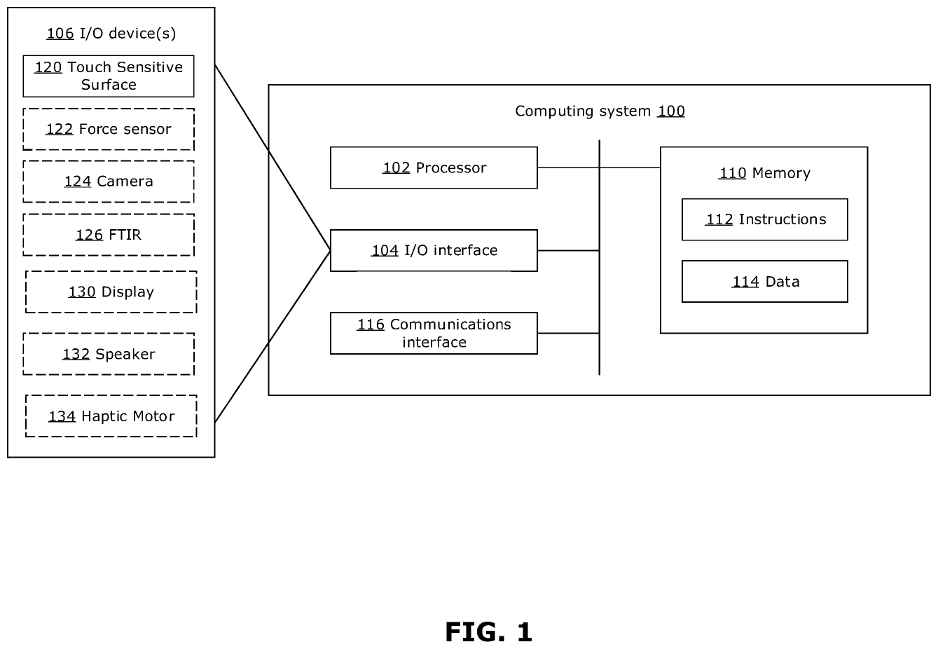

FIG. 1 is a block diagram illustrating a simplified example implementation of a computing system 100 that is suitable for implementing embodiments described herein. Examples of the present disclosure may be implemented in other computing systems, which may include components different from those discussed below. The computing system 100 may be used to execute instructions for a user-adaptive virtual keyboard software module 200, using any of the examples described herein.

The computing system 100 includes at least one processor 102, such as a central processing unit, a microprocessor, a digital signal processor, an application-specific integrated circuit (ASIC), a field-programmable gate array (FPGA), a dedicated logic circuitry, a dedicated artificial intelligence processor unit, a graphics processing unit (GPU), a tensor processing unit (TPU), a neural processing unit (NPU), a hardware accelerator, or combinations thereof.

The computing system 100 may include an input/output (I/O) interface 104, which may enable interfacing with one or more input/output devices 106. In the example shown, the I/O device(s) 106 may include a touch sensitive display 120, an optional force sensor 122, an optional camera 124 (e.g., infrared (IR) camera, RGB camera), an optional Fourier transform infrared (FTIR) spectrometer 126, an optional additional display 130, an optional speaker 132, an optional haptic motor 134, as well as other input device(s) (e.g., a mouse or pointing device, a physical keyboard, a microphone, and/or a physical keypad) and/or other output device(s) (e.g., a printer). In the example shown, the I/O device(s) 106 are shown as external to the computing system 100, however in other examples one or more of the I/O device(s) 106 may be internal to the computing system 100.

The computing system 100 may include an optional communications interface 116 for wired or wireless communication with other computing systems (e.g., other computing systems in a network). The communications interface 116 may include wired links (e.g., Ethernet cable) and/or wireless links (e.g., one or more antennas) for intra-network and/or inter-network communications.

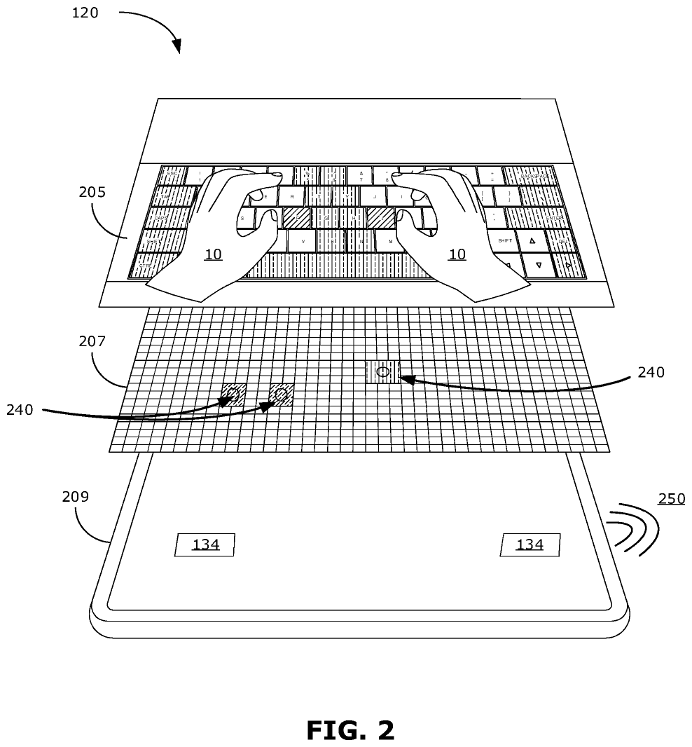

The computing system 100 may include one or more memories 110 (collectively referred to as “memory 110”), which may include a volatile or non-volatile memory (e.g., a flash memory, a random access memory (RAM), and/or a read-only memory (ROM)). The non-transitory memory 110 may store instructions 112 for execution by the processor 102, such as to carry out examples described in the present disclosure. For example, the memory 110 may store instructions for implementing any of the methods disclosed herein. The memory 110 may include other software instructions, such as for implementing an operating system (OS) and other applications or functions. The instructions 112 can include instructions for implementing the user-adaptive virtual keyboard module 200 described below with reference to FIG. 2, among other applications. The memory 110 may also store other data 114, information, rules, policies, and machine-executable instructions described herein.

In some examples, the computing system 100 may also include one or more electronic storage units (not shown), such as a solid state drive, a hard disk drive, a magnetic disk drive and/or an optical disk drive. In some examples, data and/or instructions may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage. The storage units and/or external memory may be used in conjunction with memory 110 to implement data storage, retrieval, and caching functions of the computing system 100. The components of the computing system 100 may communicate with each other via a bus, for example.

Although FIG. 1 shows a single instance of each component, there may be multiple instances of each component in the computing system 100. Further, although the computing system 100 is illustrated as a single block, the computing system 100 may be a single physical machine or device (e.g., implemented as a single computing device, such as a single workstation, single end user device, single server, etc.), and may include mobile communications devices (e.g., smartphones), laptop computers, tablets, desktop computers, among others. In some embodiments, the computing system 100 may comprise a plurality of physical machines or devices (e.g., implemented as a cluster of machines, server, or devices). In some embodiments, the computing system 100 may be a virtualized computing system (e.g., a virtual machine, a virtual server) emulated on a cluster of physical machines or by a cloud computing system.

FIG. 2 is an exploded view showing an example configuration of components of the touch sensitive display 120, which may be suitable for implementing a user-adaptive virtual keyboard module 200 in the computing system 100, in accordance with examples of the present disclosure. In examples, the user-adaptive touch sensitive display 120 may include a display component 205, for example, for displaying a user-adaptive virtual keyboard user interface (UI) 300. In examples, the touch sensitive display 120 may also include a sensing component 207. In examples, the sensing component 207 include sensors to detect a touch input by a user, for example, caused by contact with the touch sensitive display 120 by one or more fingers of the user's hand 10. The sensing component 207 may include, for example, capacitive sensors, force sensors, etc. In some embodiments, for example the sensing component 207 may generate data that may be used to measure the size, shape, and/or pressure of one or more touch events 240 corresponding to the touch input, on the touch sensitive surface 120. In examples, the touch sensitive display 120 may also include a haptic component 209 for communicating with a haptic motor 134 for providing a haptic feedback to a user who is engaging with the user-adaptive virtual keyboard UI 300. In some embodiments, for example, the haptic motor 134 may generate a haptic feedback 250 associated with anchor keys on the user-adaptive virtual keyboard UI 300 or associated with keystrokes, among others.

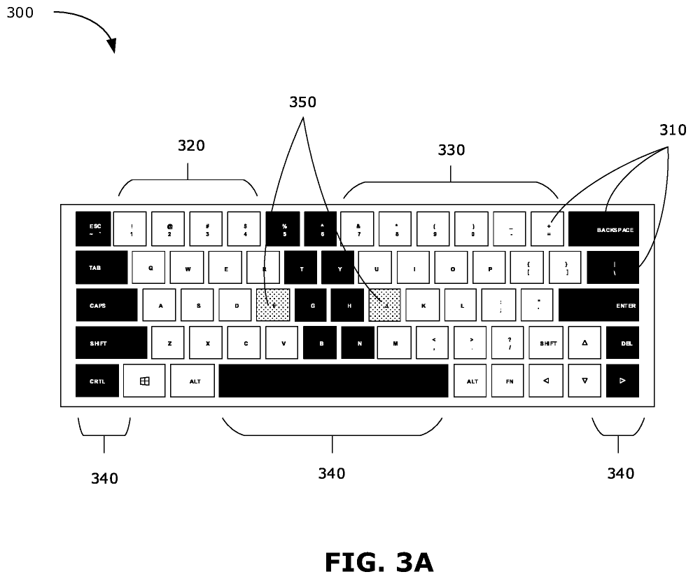

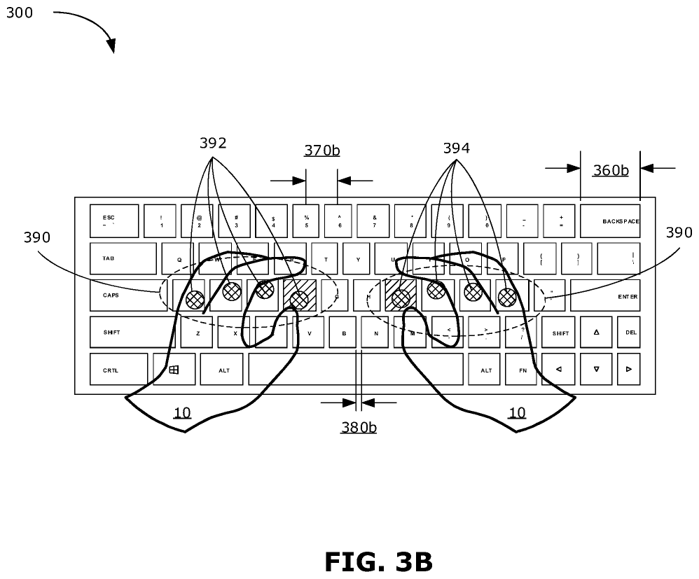

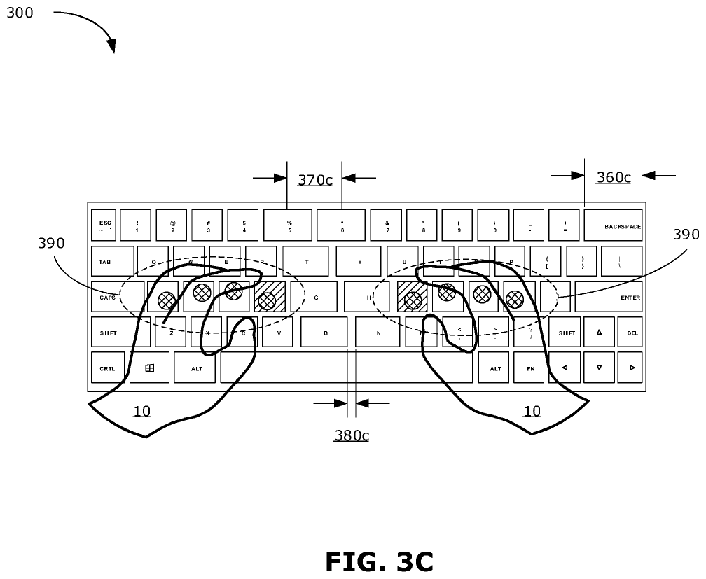

FIGS. 3A-C show example configurations of a user-adaptive virtual keyboard UI 300 that may be displayed by the touch sensitive display 120, in accordance with examples of the present disclosure. As shown in FIG. 3A, the user-adaptive virtual keyboard UI 300 may resemble a typical physical or virtual keyboard layout, for example, including a plurality of virtual objects (e.g., keys 310) corresponding to respective letters, numbers, characters or functions. While the example user-adaptive virtual keyboard UI 300 is shown having a conventional QWERTY layout that is common for use in Latin-script alphabets, it is understood that the user-adaptive virtual keyboard UI 300 may be configured with other keyboard layouts.

In some embodiments, for example, the keys 310 of the user-adaptive virtual keyboard UI 300 may be grouped into a left-hand panel 320 of virtual keys, a right-hand panel 330 of virtual keys, and a plurality of adaptive virtual keys (e.g., adaptive keys 340, represented in black in FIG. 3A). In some embodiments, for example, the plurality of adaptive keys 340 may be located in a middle region (e.g., located between the left-hand panel 320 and right-hand panel 330) and/or in one or more edge regions (e.g., located to the left of the left-hand panel 320 and located to the right of the right-hand panel 330) of the user-adaptive virtual keyboard UI 300, or the adaptive keys 340 may be located in other regions. In examples, the virtual keys of the left-hand panel 320 and the right-hand panel 330 may be static virtual objects, where properties such as key size (or key cap size), key pitch, key gap etc. are fixed in the user-adaptive virtual keyboard UI 300 and do not change while a user interacts with the user-adaptive virtual keyboard UI 300.

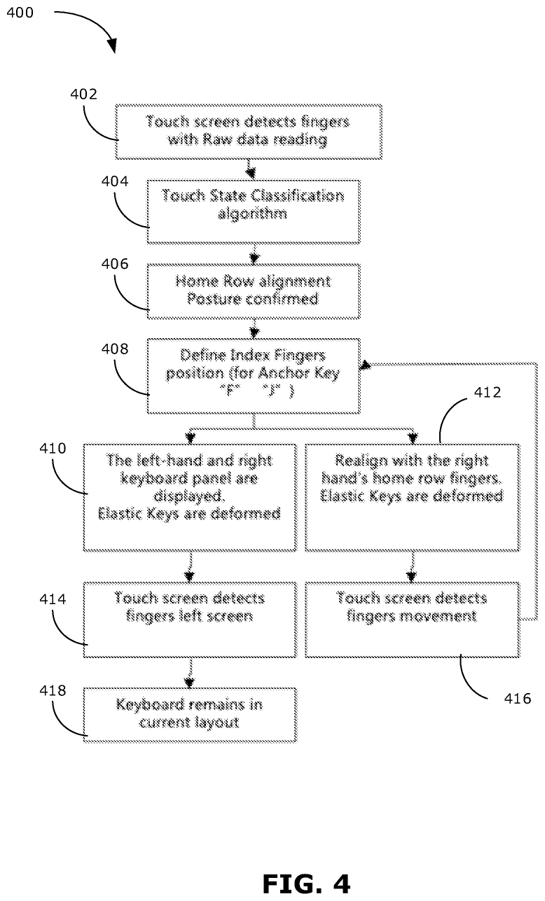

In examples, adaptive keys 340 may be dynamic virtual objects having properties (e.g., key size 360, key pitch 370, key gap 380 etc.) which can be dynamically adjusted in response to a user interaction with the user-adaptive virtual keyboard UI 300. In examples, by adjusting the properties of one or more adaptive keys 340, a user-adaptive keyboard layout of the user-adaptive virtual keyboard UI 300 may be dynamically reconfigured to improve user interaction, for example, to better accommodate a size of a user's hands 10 or to suit a user's preferences, among others. For example, as shown in FIG. 3B, the distance between the left-hand panel 320 and a right-hand panel 330 in the user-adaptive virtual keyboard UI 300 may be decreased (e.g., brought closer together), for example, by reducing the key pitch 370b or reducing the key gap 380b associated with the adaptive keys 340 located in a middle region of the keyboard layout (e.g., a first column including keys “5”, “T”, “G” and “B” and a second column including keys “6”, “Y”, “H” and “N”, and including a space bar) and/or increasing the key size 360b for columns of adaptive keys 340 located on the far right and left edges of the keyboard layout. In another example, as shown in FIG. 3C, the distance between the left-hand panel 320 and a right-hand panel 330 in the user-adaptive virtual keyboard UI 300 may be increased (e.g., moved farther apart) by increasing the key pitch 370c or increasing the key gap 380c associated with the adaptive keys 340 located in the middle region of the keyboard layout and/or reducing the key size 360c for columns of adaptive keys 340 located on the far right and left edges of the keyboard layout. In examples, the properties of adaptive keys 340 may be dynamically adjusted based on the user's home row finger positions 390, for example, using a method described with respect to FIG. 4. The home row finger positions 390 may be defined as the positions (or regions) corresponding to the home row virtual keys of the user-adaptive virtual keyboard UI 300. In some examples, the home row finger positions 390 may include a respective left home row position 392 for each finger of the left hand and a respective right home row position 394 for each finger of the right hand.

FIG. 4 is a flowchart illustrating an example method 400 for dynamically adjusting one or more adaptive keys 340 of the user-adaptive virtual keyboard UI 300, in accordance with examples of the present disclosure. The method 400 may be implemented by the computing system 100 executing instructions of the user-adaptive virtual keyboard module 200 (which may be stored in memory 110), for example. In examples, method 400 begins at step 402 in which the touch sensitive display 120 (also referred to as a touch screen) detects a touch input (e.g., via contact data generated by the sensing component 207), for example, as contact (or near contact) by one or more fingers of a user's hand 10 on the touch sensitive display 120. In examples, the touch sensitive display 120 may be configured to continuously monitor for a touch input 510 and in response to detecting a touch input, may record and store contact data associated with the touch input.

In examples, at step 404, the contact data may be processed using a touch state classification algorithm to confirm, at step 406, whether the touch input represents an intentional home row posture by the user (e.g., where the user's fingers are resting and/or positioned in a “ready state” or a “home row posture” over the virtual keys associated with the home row on the user-adaptive virtual keyboard UI 300, prior to initiating typing) or whether the touch input was an accidental touch by the user.

At step 408, in response to confirming that a user's hands are positioned in the home row posture, the computing system 100 may determine respective coordinates on the touch sensitive display 120 representative of the user's left index finger and right index finger, as anchor positions for anchor keys (e.g., virtual keys “F” and “J” in a QWERTY layout). In examples, the computing system 100 may use the detected anchor positions, or detected positions for multiple fingers in contact with the touch sensitive display 120 while resting over home row keys, for example, to perform a home row calibration.

At step 410, the user-adaptive virtual keyboard UI 300 may be outputted to be displayed by the touch sensitive display 120, including display of the left-hand panel 320, the right-hand panel 330 and the plurality of adaptive keys 340 (also referred to as elastic keys). In examples, the plurality of adaptive keys 340 may be displayed in a “deformed state”, for example, where the properties of the adaptive keys 340 may be configured to produce a virtual keyboard layout that is customized to the user's needs or preferences, based on the detected anchor positions.

In examples, at step 414, the touch sensitive display 120 may detect that a user's fingers are no longer in contact with the touch sensitive display 120, for example, the user has lifted their fingers from the touch sensitive display 120. In response, at step 418, the current key configuration may be maintained and the user-adaptive virtual keyboard UI 300 may continue to be displayed in its current layout. The method 400 may wait for the user to resume interacting with the touch sensitive display 120, for example, returning to step 402 when the user resumes contact with the touch sensitive display 120.

Returning to step 408, in some examples, the computing system 100 may determine that one or both of the user's hands 10, while interacting with the user-adaptive virtual keyboard UI 300, have shifted from a previously determined home row posture. For example, as a user performs typing actions using the user-adaptive virtual keyboard UI 300, their left hand and/or right hand may drift over the touch sensitive display 120, for example, moving upwards or to the right, among other directions. In examples, the computing system 100 may determine that a home row re-calibration is required, for example, by determining that the user's current anchor positions are significantly different from the previous anchor positions, or the touch sensitive display 120 may detect that the user has placed eight fingers in contact with the touch sensitive display 120 for an extended time to manually initiate a recalibration, among others. In examples, at step 412, the computing system 100 may recalibrate the home row posture and dynamically adjust the adaptive keys 340 of the user-adaptive virtual keyboard UI 300 to realign the left-hand panel 320 and/or the right hand panel 330 to reflect the shifted hand position(s). For example, the properties of the adaptive keys 340, such as such as key size 360, key pitch 370 and key gap 380, may be dynamically adjusted in the user-adaptive virtual keyboard UI 300 to reflect the change in detected anchor positions.

At step 416, the touch sensitive display 120 may detect further touch input caused by finger movements (e.g., typing actions) by the user on the touch sensitive display 120 and the method 400 may return to step 408 to re-evaluate the position of the user's hands with respect to the anchor positions (e.g., for virtual keys “F” and “J”) on the touch sensitive display 120. In this regard, the method 400 may help improve the user experience during blind typing, by enabling the virtual keyboard UI to adapt to the user's finger position, thus helping users to more accurately and efficiently type on a virtual keyboard using existing muscle memory, and without visual assistance.

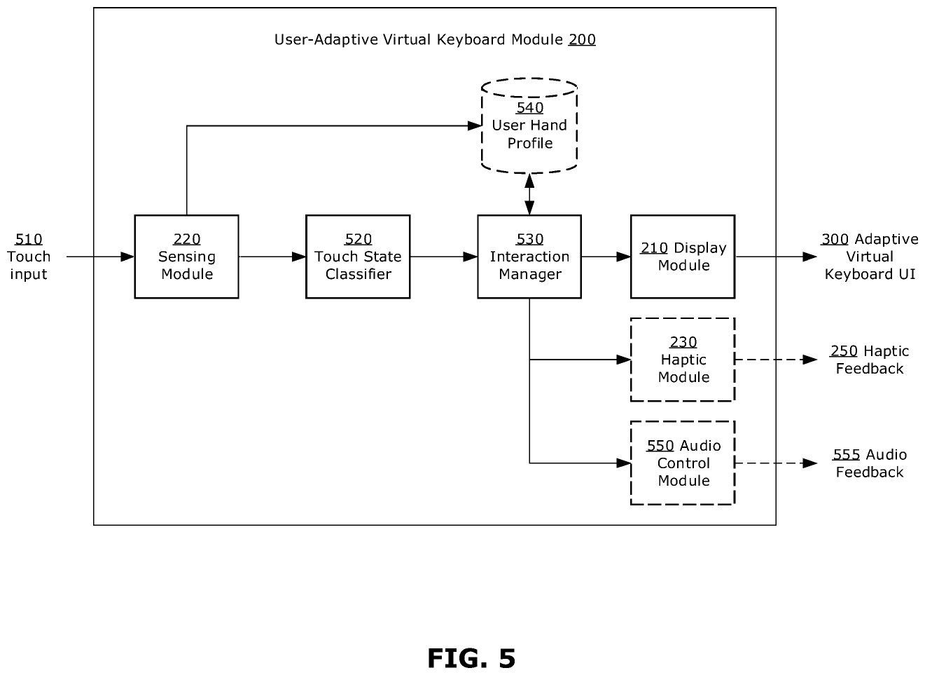

FIG. 5 shows a block diagram of an example architecture for the user-adaptive virtual keyboard module 200, in accordance with examples of the present disclosure. The user-adaptive virtual keyboard module 200 may be software that is implemented in the computing system 100 of FIG. 1, in which the processor 102 is configured to execute instructions of the user-adaptive virtual keyboard module 200 stored in the memory 110. The user-adaptive virtual keyboard module 200 in this example includes a sensing module 220, a touch state classifier 520, an interaction manager 530, a display module 210, and optionally, a haptic module 230 and an audio control module 550, and generates a user-adaptive virtual keyboard UI 300 for display by the touch sensitive display 120.

In examples, a touch input 510 caused by fingers of the user's hand 10 contacting (or nearly contacting) the touch sensitive display 120 may cause contact data to be generated (e.g., via the sensing component 207). In examples, the sensing module 220 may be configured to continuously monitor for contact data representing a touch input 510 and in response to detecting a touch input 510, may record and store raw contact data associated with the touch input 510. In examples, the touch sensitive display 120 may be a capacitive touch sensitive display, such as a super-resolution capacitive touch screen, where a capacitive touch screen draws small electrical charges to a point of contact, and functions as a capacitor in the region of contact. In some examples, in response to a finger of the user's hand 10 being placed in contact with the capacitive touch sensitive display, a change in the capacitance and electrostatic field in the capacitive panel of the touch sensitive display 120 provides 2D location information corresponding to the contact position of the finger as the raw contact data. In examples, the sensing module 220 may process the raw contact data to generate processed contact data, for example, as one or more capacitive images for a respective one or more fingers of the user's hand 10. In some embodiments, for example, a force sensor 122 may measure forces applied to the touch sensitive display 120 by the one or more fingers of the user's hand 10 and the sensing module 220 may record and store the measured forces (e.g., normal or shear forces), or other input data may be detected and/or processed by the sensing module 220.

In examples, the sensing module 220 may feed the raw or processed contact data to a touch state classifier 520 to determine a user hand state. In examples, the touch state classifier 520 may determine, based on the one or more capacitive images or optionally, based on other input data, if the user's hand posture represents a “ready state”, for example, where the user's fingers are resting and/or positioned in a home row posture over the virtual keys associated with the home row on the user-adaptive virtual keyboard UI 300. In other examples, the user hand state may represent an accidental touch by the user.

In examples, in response to determining that the user hand state is in a “ready state”, the interaction manager 530 may determine respective coordinates on the touch sensitive display 120 representative of the user's left index finger and right index finger, as anchor positions for virtual keys “F” and “J”. In examples, the interaction manager 530 may use the detected anchor positions, or detected positions for multiple fingers in contact with the touch sensitive display 120 while resting over home row keys, for example, to perform a home row calibration. In examples, the interaction manager 530 may configure respective parameters of the plurality of adaptive keys 340, for example, key size, key pitch, key gap, etc. according to the home row calibration, and optionally, based on a stored user hand profile 540 for a particular user (for example, as described with respect to FIG. 11), for generating the user-adaptive virtual keyboard UI 300.

In examples, the display module 210 may output the user-adaptive virtual keyboard UI 300, including the left-hand panel 320, the right-hand panel 330 and the plurality of adaptive keys 340, according to the configured parameters of the plurality of adaptive keys 340, for display by the touch sensitive display 120. In examples, the plurality of adaptive keys 340 may be displayed in a “deformed state”, for example, to produce a virtual keyboard layout that is customized to the user's needs or preferences, based on the detected anchor positions.

In some embodiments, for example, the interaction manager 530 may also communicate with an optional haptic module 230 to generate a haptic feedback 250 (e.g., via the haptic component 209) associated with a user interaction with the user-adaptive virtual keyboard UI 300. For example, a haptic feedback 250 may be generated to notify users when they are in a home row position, or associated with anchor positions “F” and/or “J”, among others. In other embodiments, for example, the interaction manager 530 may also communicate with an optional audio control 550 to generate an audio feedback 555 (e.g., via a speaker 132) associated with a user interaction with the user-adaptive virtual keyboard 200. For example, an audio feedback 555 may be generated to notify users when their hand position is shifting away from the home row position, among others.

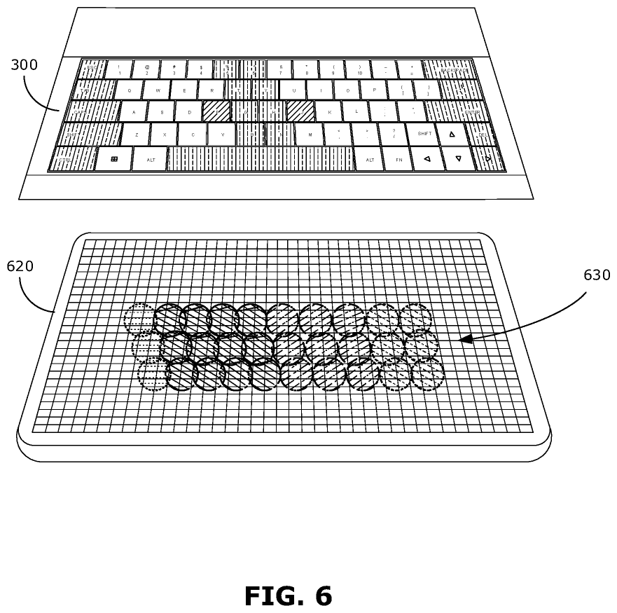

FIG. 6 illustrates another example embodiment of a user-adaptive virtual keyboard UI 300, in accordance with examples of the present disclosure. In the example shown, a motion space layer 620 is provided. Typically, virtual keyboards on current electronic devices, such as smart phones or tablets, commonly use a Bayesian model for defining a static motion space around each key in the virtual keyboard. However, this approach for mapping screen inputs to a corresponding motion space becomes unreliable when the virtual keyboard layout is not fixed, for example, when the left-hand panel 320 and the right-hand panel 330 of the user-adaptive virtual keyboard UI 300 are adaptively repositioned based on the user's changing hand positions. In examples, the user-adaptive virtual keyboard module 200 may be executed to perform operations to adjust a respective motion space 630 based on home row position and/or may be updated with each home row calibration, to reflect any shift in hand position while a user is typing. In this regard, the motion space 630 may be dynamically updated to align with any dynamic UI changes related to adjustments in the user-adaptive virtual keyboard UI 300. A motion space layer 620, in the present disclosure, refers to a logical layer that may be used to map the location of a touch event to a particular key in the UI based on the motion space 630 of that particular key. Thus, the motion space layer 620, although illustrated as a layer below the user-adaptive virtual keyboard UI 300, may not be a physical component of the computing system 100.

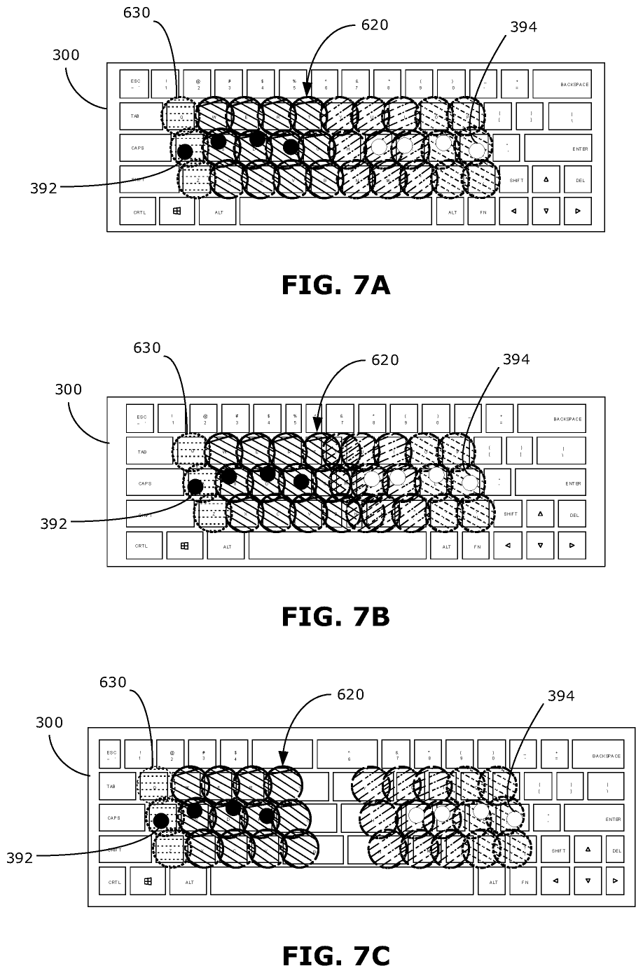

FIGS. 7A-C show examples of how the motion space 630 of a motion space layer 620 may map to virtual keys of the user-adaptive virtual keyboard UI 300, in accordance with examples of the present disclosure. In examples, the sensing module 220 may detect the user's home row finger positions on the touch sensitive display 120, for example, while the user's fingers are resting on the screen. The motion spaces 630 corresponding to the home row keys may be adjusted based on a user's home row finger position. FIG. 7A shows the motion space layer 620, comprising a respective motion space 630 for the virtual keys that may be reached by each finger of the left-hand and the right-hand. For example, a motion space layer 620 may include motion spaces 630 corresponding to an index finger of the right-hand, including a Bayesian model (or another probabilistic model) to map a touch input to the “Y”, “H”, “N”, “U”, “J” and “M” keys, and motion spaces 630 corresponding to the middle finger of the left hand may map screen inputs to the “E”, “D” and “C” keys. In examples, adjusting the motion spaces 630 to correspond to the detected the home row finger positions may involve shifting the motion spaces 630 inward or outward, or up and down, to accommodate the home row finger positions and any associated changes in the UI layout.

In some examples, as shown in FIG. 7B, when the distance between the detected left home row positions 392 (indicated by black circles) and the detected right home row positions 394 (indicated by white circles) is decreased, the motion spaces 630 corresponding to the keys that may be touched by the index finger of the user's left hand and the motion spaces 630 corresponding to keys that may be touched by the index finger of the user's right hand may overlap. Additionally, the distance between the left-hand panel 320 and a right-hand panel 330 of the user-adaptive virtual keyboard UI 300 is decreased. In contrast, as shown in in FIG. 7C, when the distance between the detected left home row positions 392 (indicated by black circles) and the detected right home row positions 394 (indicated by white circles) is increased, the motion spaces 630 corresponding to the keys that may be touched by the index finger of the user's left hand and the motion spaces 630 corresponding to the keys that may be touched by the index finger of the user's right hand may be spatially separated. Additionally, the distance between the left-hand panel 320 and a right-hand panel 330 of the user-adaptive virtual keyboard UI 300 is increased.

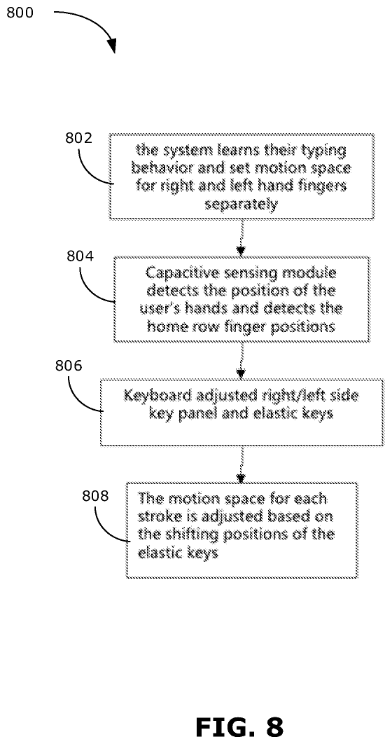

FIG. 8 is a flowchart illustrating an example method 800 for dynamically adjusting the motion spaces 630 for mapping touch events to virtual keys of the user-adaptive virtual keyboard UI 300, in accordance with examples of the present disclosure. The method 800 may be implemented by the computing system 100 executing instructions of the user-adaptive virtual keyboard module 200 (which may be stored in memory 110), for example. In examples, method 800 begins at step 802 in which a motion state model is trained. In examples, sensing module 220 detects a touch input 510 including one or more touch events corresponding to a typing action. In examples, the sensing module 220 may detect a left home row position 392 for each finger of the user's left hand and a right home row position 394 for each finger of the user's right hand, using touch screen individual finger position sensing. In examples, the sensing module 220 may feed the touch input 510 along with corresponding home row position information as training data to a motion space model for training the model to learn the user's typing behavior and touch patterns associated with the user's left hand fingers and right hand fingers during blind typing. In examples, the trained motion space model may predict a motion space 630 for each finger on a user's left and right hand, based on a home row position. In examples, the motion space model may be a machine learning model or another model may be used.

In examples, at step 804, the sensing module 220 may detect a touch input 510 and may determine a position of the user's hands, including a respective left home row position 392 for each finger of the user's left hand and a respective right home row position 394 for each finger of the user's right hand.

In examples, at step 806, the computing system 100 may adjust the position of the left-hand panel 320 and the right-hand panel 330 by modifying the parameters of adaptive keys 340, to display the user-adaptive virtual keyboard UI 300, for example, as described with respect to method 400 of FIG. 4.

In examples, at step 808, the motion spaces 630 may be updated to reflect the virtual keys of the user-adaptive virtual keyboard UI 300 that may be touched by the fingers of the left and right hands. For example, this adjustment to the motion spaces 630 may involve shifting the motion spaces 630 inward or outward, or up or down, to accommodate the home row finger positions 390 and any associated changes in the user interface layout. In this regard, dynamically adapting the motion spaces 630 based on the detected home row finger positions 390 ensures that the motion spaces 630 remain accurate and reliable for each touch event, even as the user's hand position drifts. In this regard, the method 800 provides a technical effect of allowing users to maintain precise and consistent typing on the user-adaptive virtual keyboard UI 300, regardless of how the user's hand position changes over time and regardless of how the layout of the user-adaptive virtual keyboard UI 300 adjusts to account for changes in user hand position.

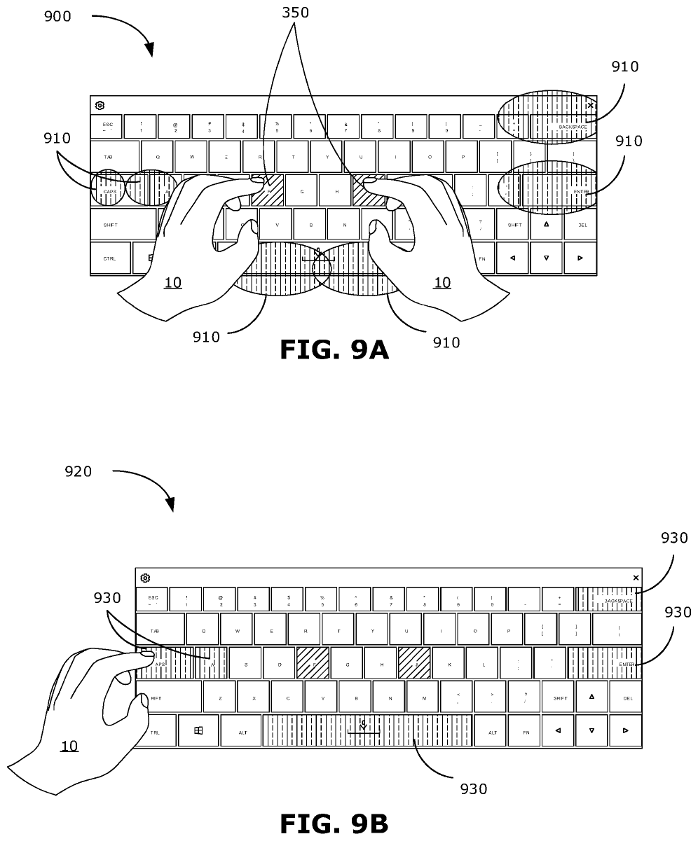

FIGS. 9A-B show example configurations of a functional key motion space, in accordance with examples of the present disclosure. During blind typing, it is common for users to accidentally or unintentionally trigger touch events to be detected on the touch sensitive display 120. For example, these erroneous touch events are particularly common in association with functional keys that are engaged by the 5^{th} finger (e.g., smallest finger/pinky finger) or the 4^{th} finger (e.g., ring finger) during a typing action. In examples, these erroneous touch events may be caused by factors such as difficulty in reaching functional keys with the 5^{th} finger, for example, due to the lack of a tactile hint to locate keys, resting the 5^{th} finger on the touch sensitive display 120 and/or co-activation of keys. In examples, these erroneous touch inputs may commonly cause unintended activation of the “Caps” key, mis-triggers of surrounding keys like the “Backspace” or “Enter” keys, difficulties engaging the “Shift” key and difficulties in accurately activating the spacebar due to palm rejection, among other problems.

In examples, the motion space mapping associated with functional keys may be configured to dynamically change based on a user's typing status, for example, depending on whether a user is an experienced typist performing a blind typing action (e.g., 10-finger typing while looking away from the keyboard) or whether the user is an inexperienced typist, or performing visual typing (e.g., two-finger typing while looking at the keyboard), to help prevent accidental touch events or missing touch events. As shown in FIG. 9A, a Gaussian motion space model 900 may be used in which motion spaces 910 are mapped to functional keys when the user is determined to be an experience typist performing a blind typing action. In contrast, as shown in FIG. 9B, when a user is determined to be inexperienced and requiring visual assistance, a UI-linked motion space model 920 may be used in which the model spaces 930 are defined by the boundaries of the displayed virtual functional keys. In examples, a Gaussian motion space model 900 may follow a Gaussian distribution, whereas a UI-linked motion space model 920 may map directly to functional key boundaries as defined by the user-adaptive virtual keyboard UI 300.

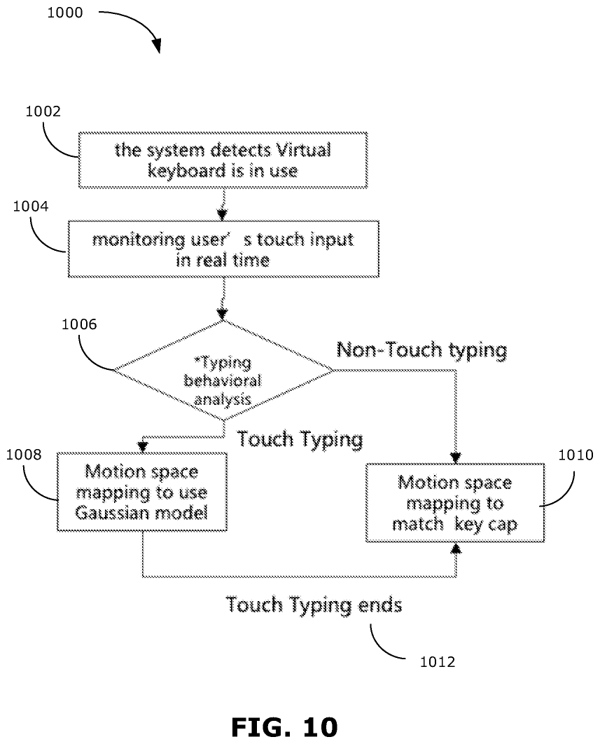

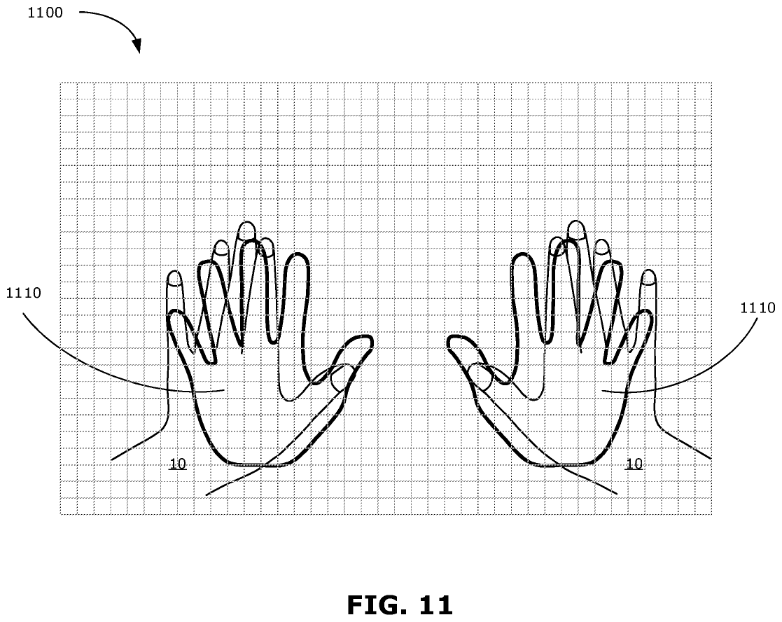

FIG. 10 is a flowchart illustrating an example method 1000 for mapping a motion space to functional keys in the user-adaptive virtual keyboard UI 300, in accordance with examples of the present disclosure. The method 1000 may be implemented by the computing system 100 executing instructions of the user-adaptive virtual keyboard module 200 (which may be stored in memory 110), for example. In examples, method 1000 begins at step 1002 in which the sensing module 220 detects that the user-adaptive virtual keyboard UI 300 is in use. In examples, at step 1004, the computing system 100 may monitor user touch inputs in real time, to assess the typing behavior at step 1006.

In examples, the typing behavioral analysis of step 1006 may be based on contextual sensing using standard touch screen or enhanced capacitive super resolution sensing. Factors such as the user's typing finger postures (e.g., number of fingers used, reliance on small finger input), typing speed (e.g., keystrokes per minute) and/or identification of the finger in use for reaching special keys may be considered. Based on these factors, the computing system 100 may determine whether the user is performing touch typing or non-touch typing, and thus determine the appropriate motion space mapping, ensuring a more accurate and efficient typing experience tailored to the user's needs and capabilities. In some examples, another approach to behavioral typing analysis may include capacitive sensing. For example, capacitive sensing may be used to detect finger shape in contact with screen, to predict the finger that is touching the user-adaptive virtual keyboard UI 300, as a basis for determining whether the typing status is touch typing or non-touch typing (e.g., to predict whether a touch input to activate a “Shift” key or an “A” key is performed using an index finger (e.g., as in non-touch typing) or using a 5^{th} finger (e.g., as in touch typing)). Based on the typing behavioral analysis, the computing system 100 may classify whether the typing status is blind touch typing or visual (e.g., non-touch) typing.

In examples, if the typing status is classified as blind touch typing, at step 1008, motion space mapping for functional keys may apply a Gaussian model. In examples, using an enhanced Gaussian model region as the motion space provides more precise targeting and reduces the risk of accidental touches.

In examples, if the typing status is classified as visual (non-touch) typing, at step 1010, motion space mapping for functional keys may be mapped to the key boundaries (i.e., key cap regions) of the user-adaptive virtual keyboard UI 300, enabling easier visual identification of keys.

In examples, at step 1012, the sensing module 220 determines that a touch typing action has ended, for example, when the user lifts their hands from the touch sensitive display 120. In examples, the motion space mapping for functional keys may be changed to be mapped to the key boundaries of the user-adaptive virtual keyboard UI 300, as described in step 1010.

FIG. 11 illustrates an example onboarding session 1100 (also referred to as a calibration session) for measuring a user's hands 10, in accordance with examples of the present disclosure. In examples, a one-size-fits-all approach to generating virtual keyboards does not accommodate the natural variation in hand size among individuals, for example, of different genders and ages. In this regard, trying to use a virtual keyboard that is too big or too small for a user's hands is difficult and can lead to discomfort and frustration when using the keyboard. In examples, an onboarding session may be used to gather information about a user's hand size, (such as palm size, finger length, finger span, or other distances or ratios, etc.) to further personalize the user-adaptive virtual keyboard UI 300 to accommodate a user's hand size.

In examples, the sensing module 220 may be used to obtain measurements of the user's hands. For example, the computing system 100 may generate a request (e.g., a visual pop-up notification) to the user to place the user's hands 10 flat on the touch sensitive display 120 so that contact data can be obtained to measure the palm width, finger length, distance between fingers (e.g., distance between index finger and ring finger), among other measurements. In some examples, a handprint guide 1110 may be displayed on the touch sensitive display 120 to guide the user in placing their hands 10 in a flat orientation on the touch sensitive display 120, enabling the sensing module 220 to detect the user's full hand shape (e.g., using capacitive sensing) and to obtain hand measurements from a generated capacitive hand image. In examples, a user hand profile 540 may be generated based on the hand measurements. The user hand profile 540 may be stored as data that may be accessed by the user-adaptive virtual keyboard module 200, for example.

In other examples, hand measurements may be determined by analyzing data related to the home row resting posture of the user's dominant typing fingers, such as the index finger, middle finger, and ring finger. For example, distances between home row positions may be analyzed to infer the distance between those fingers on the user's hands 10 and to predict a corresponding hand size. In examples, a user hand profile 540 may be generated based on the predicted hand size. In other examples, a camera 124 may be used to capture an image of a user's hands, and the image may be analyzed to infer the user's hand measurements. In examples, a user hand profile 540 may be generated based on the inferred hand measurements.

In examples, the user-adaptive layout of the user-adaptive virtual keyboard UI 300 may be dynamically reconfigured based on the user's hand profile 540. For example, properties of the adaptive keys 340 (e.g., key size, key pitch or aspect ratio, among others) may be adjusted based on one or more characteristics of the user's hand, such as finger length, finger-finger distance or fingertip size, etc. By tailoring the user-adaptive virtual keyboard UI 300 to accommodate the individual differences in a user's hand size, examples of the present disclosure may ensure a more comfortable and efficient typing experience. In examples, after an onboarding session has been performed and a user hand profile 540 has been generated and stored, a user may be recognized based on their hand characteristics matching an existing hand profile 540 in a later onboarding session. For example, the user may be recognized based on one or more hand measurements by comparing the hand measurements obtained at a current onboarding session to an existing user hand profile 540 (generated and stored from a previous onboarding session) and determining a match. In examples, a customized user-adaptive virtual keyboard UI 300 may have been previously determined for the user and stored with the user hand profile. Then, based on a match with the user's user hand profile 540, the customized user-adaptive virtual keyboard UI 300 may be retrieved from memory and displayed.

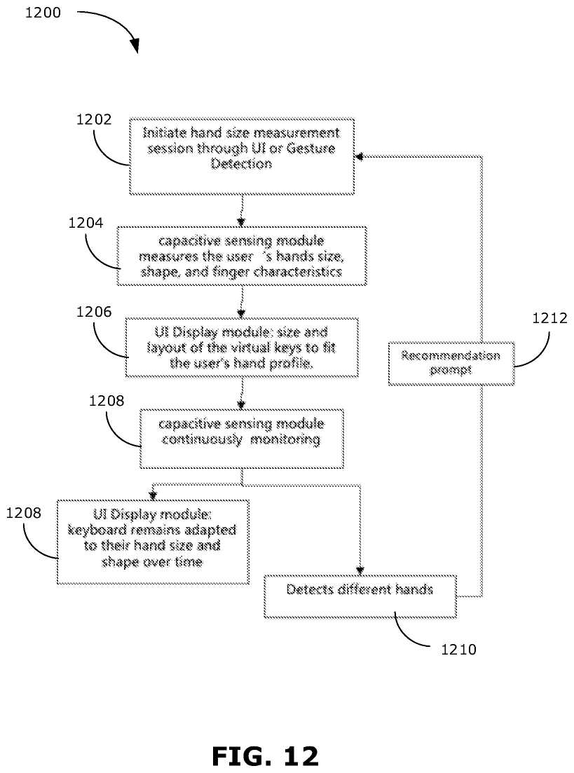

FIG. 12 is a flowchart illustrating an example method 1200 for generating the user-adaptive virtual keyboard UI 300 based on a user hand profile 540, in accordance with examples of the present disclosure. The method 1200 may be implemented by the computing system 100 executing instructions of the user-adaptive virtual keyboard module 200 (which may be stored in memory 110), for example. In examples, method 1200 begins at step 1202 in which a virtual keyboard calibration is initiated, for example, through a prompt outputted by the computing system 100 (e.g., a pop-up notification) or through detecting a predetermined gesture, for example, a mid-air gesture or a contact gesture detected by the sensing module 220. In examples, at step 1204, in response to the user placing their hands on the touch sensitive display 120 (which in this example is a capacitive touch sensitive display), the sensing module 220 may obtain measurements of the hand from sensor data (e.g., capacitive sensor data). For example, a capacitive image corresponding to each of the user's hands 10 may be generated and used to measure characteristics of the user's hands, including hand size, hand shape, finger length, among other characteristics. In examples, a user hand profile 540 may be generated for the user based on the hand measurements.

In examples, at step 1206, the computing system 100 may adjust the properties of adaptive keys 340 to generate a custom layout of the user-adaptive virtual keyboard UI 300 based on the user hand profile 540 obtained via the virtual keyboard calibration. In examples, the display module 210 may output the user-adaptive virtual keyboard UI 300 reflecting the custom layout to be displayed by the touch sensitive display 120.

In examples, at step 1208, the sensing module 220 may continuously monitor user activity to determine whether the user remains the same user or whether another user (e.g., a new user, a past user etc.) is interacting with the user-adaptive virtual keyboard UI 300. In examples, when the user is determined to be the same user, at step 1210, the display module 210 may continue to output the user-adaptive virtual keyboard UI 300 corresponding to the user hand profile 540. In examples, at step 1210, the sensing module 220 may determine that the user is a different user, for example, the sensing module 220 may detect different hand characteristics that suggests that a different user is interacting with the user-adaptive virtual keyboard UI 300. In examples, in response to detecting hand belonging to a different user, a recommendation prompt may be generated and output to the touch sensitive display 120, at step 1212, prompting the new user to perform a virtual keyboard calibration, for example, returning to step 1202.

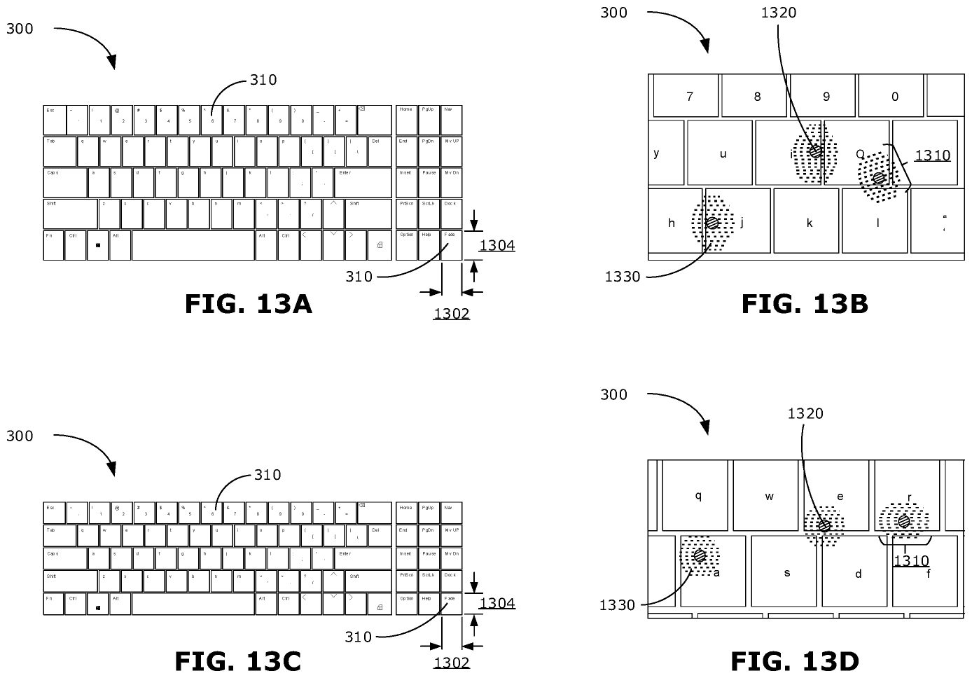

FIGS. 13A-D show example configurations of the user-adaptive virtual keyboard UI 300 with respect to a capacitive finger image 1310, in accordance with examples of the present disclosure. In examples, a capacitive finger image 1310 refers to the contact area that a finger occupies on the touch sensitive display 120 (e.g., during blind typing). Examples of capacitive finger images 1310 are provided in FIGS. 13B and 13D, for example, where a capacitive finger image 1310 includes a centroid 1320 and a surrounding body 1330, and where the shape of the body 1330 is dependent on the surface area of a user's finger that is in contact with a capacitive touch sensitive display 120, and the intensity of the contact.

In some embodiments, for example, the aspect ratio of a virtual key 310 may be determined based on the shape and size of a capacitive finger image 1310. In examples, the aspect ratio of a virtual key 310 describes the ratio of the key width 1302 to the key height 1304. For example, the aspect ratio of keys 310 as shown in FIG. 13A is taller and narrower than the aspect ratio of keys 310 as shown in FIG. 13C. In examples, adjusting the aspect ratio of the keys 310 of the user-adaptive virtual keyboard UI 300 to match the average size of a user's capacitive finger images 1310 may improve user experience and blind typing accuracy. In examples, benefits of interacting with a keyboard with an appropriate aspect ratio include: an ability to maintain a comfortable, more ergonomic hand placement while typing, for example, reducing strain on hands and fingers and wrists, helping to prevent repetitive strain injuries and extending typing duration before feeling fatigued; reduced errors for example, reducing the chance of accidentally hitting an incorrect key; and improved typing speed.

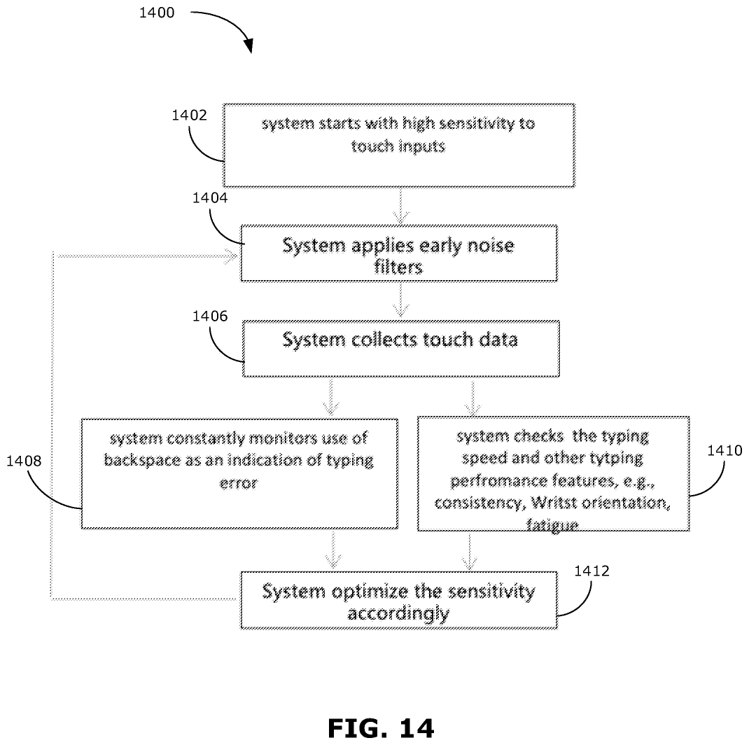

FIG. 14 is a flowchart illustrating an example method 1400 for adjusting a sensitivity threshold of the sensing module 220 of the user-adaptive virtual keyboard module 200, in accordance with examples of the present disclosure. The method 1400 may be implemented by the computing system 100 executing instructions of the user-adaptive virtual keyboard module 200 (which may be stored in memory 110), for example. In examples where the touch sensitive display 120 is a capacitive touch sensitive display, the touch sensitivity threshold of the sensing module 220 can refer to a minimum sensing value of a capacitive touch sensitive surface for what is considered to be a touch input 510. In examples, adjusting the sensitivity threshold may improve user experience when interacting with the user-adaptive virtual keyboard UI 300 by improving typing accuracy and providing a more intuitive and efficient typing experience for the user. In examples, method 1400 begins at step 1402 in which an initial sensitivity threshold is applied for detecting touch inputs 510 by the sensing module 220, where the initial sensitivity threshold is a high value. This means that even very light touches (which may include unintentional touches, such as a user brushing their fingers over the touch sensitive display 120) may be detected as a touch event. At step 1404, one or more initial filters are applied to touch input data detected by the sensing module 220, for example, for removing noise in the touch input data.

In examples, at step 1406, the sensing module 220 collects and stores a predetermined amount of touch data corresponding to a plurality of touch inputs 510 while a user is interacting with the user-adaptive virtual keyboard UI 300, for example, for analyzing one or more characteristics of the user's typing behavior (e.g., typing pressure, typing cadence or timing, etc.). In examples, analysis of typing behavior may include, at step 1408, monitoring the frequency of use of a “backspace” key as an indication of the occurrence of typing error, or at step 1410, evaluating typing speed and other typing performance features such as typing consistency, cadence, wrist orientation or user fatigue.

In examples, at step 1412, the initial sensitivity threshold may be adjusted based on the analysis of typing behavior. In an example, the sensitivity threshold may be reduced in response to indications from the typing behavior that the sensitivity is too high, for example, by indication of too many accidental touch errors, or by indication of temporal characteristics of the user's typing behavior. In examples, method 1400 may return to step 1404 and iteratively adjust the sensitivity threshold until an optimal sensitivity threshold for the user is obtained, for example, using a feedback mechanism to continuously monitor and assess typing behavior in response to adjustments in the sensitivity threshold, and to accommodate variations in the user's typing style over time. In some embodiments, for example, machine learning algorithms can be employed to detect patterns in user typing behavior and execute dynamic adjustments to optimize touch sensitivity.

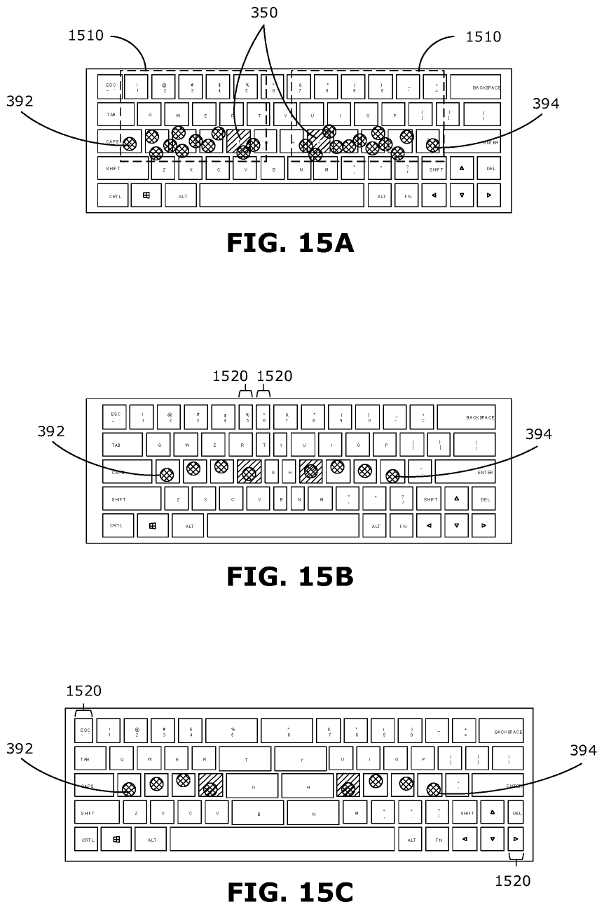

FIGS. 15A-C show example configurations of a user-adaptive virtual keyboard UI 300 with respect to an adaptive keyboard home row safe zone 1510, in accordance with examples of the present disclosure. In examples, a home row safe zone 1510 represents a range of home row finger positions (e.g., left home row finger positions 392 and right home row finger positions 394) based on a minimum adaptive key width 1520. In examples, during interaction with the user-adaptive virtual keyboard 200, users may unintentionally place their fingers in a home row position that renders the adaptive keyboard difficult to use, for example, with their anchor fingers “F” and “J” too close together (e.g., causing the adaptive keys 340 along the center of the keyboard may become too narrow) or too far apart (e.g., causing the adaptive keys 340 at the outer edges of the keyboard layout to become too narrow). When this occurs, the user-adaptive virtual keyboard 200 may serve an error notification or hint to the user, indicating that the user's hands are outside of the home row safe zone 1510. By notifying a user when their hands are approaching or are outside the home row safe zone 1510, the user may adjust their hand position to maintain optimal operation of the user-adaptive virtual keyboard 200.

In some embodiments, for example, the home row safe zone 1510 is shown in FIG. 15A as encompassing a range of left home row finger positions 392 and right home row positions 394, where the range of home row finger positions is determined based on a user hand profile 540 and a minimum adaptive key width. In examples, the configurations of FIGS. 15B and 15C are representative of configurations approaching a safe zone limit, where the adaptive keys 340 at the center of the user-adaptive virtual keyboard UI 300 are configured at the minimum key width 1520 (FIG. 15B) or the adaptive keys 340 at the outer edges of the user-adaptive virtual keyboard UI 300 are configured at the minimum key width 1520 (FIG. 15C).

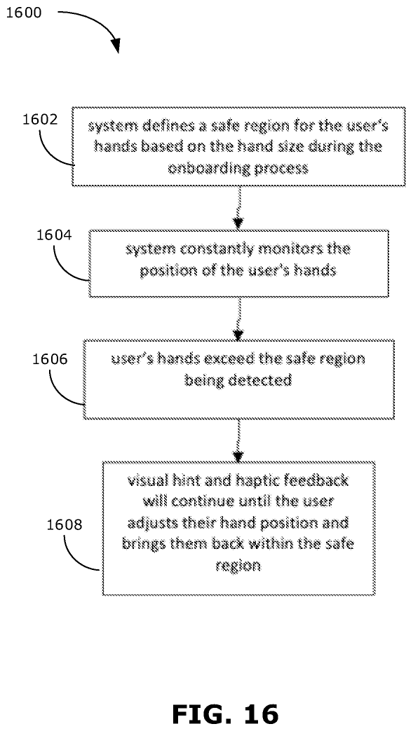

FIG. 16 is a flowchart illustrating an example method 1600 for generating notifications to users regarding the adaptive keyboard home row safe zone 1510, in accordance with examples of the present disclosure. The method 1600 may be implemented by the computing system 100 executing instructions of the user-adaptive virtual keyboard module 200 (which may be stored in memory 110), for example. In examples, method 1600 begins at step 1602 in which the computing system 100 determines the boundaries of the adaptive keyboard home row safe zone 1510, based on the user hand profile 540. In examples, at step 1604, the sensing module 220 monitors the user's home row finger positions 390 while the user interacts with the user-adaptive virtual keyboard UI 300, and compares the home row finger positions 390 with the boundaries of the adaptive keyboard home row safe zone 1510.

In examples, at step 1606, the sensing module 220 detects one or more of the home row finger positions has moved outside of the adaptive keyboard home row safe zone 1510. In some embodiments, for example, the sensing module 220 may detect that one or more of the home row finger positions has moved near to the boundary of the adaptive keyboard home row safe zone 1510, for example, within a threshold distance from the boundary. In some examples, step 1606 may involve determining that one or more adaptive keys 340 would be narrower than the minimum key width 1520 if the one or more adaptive keys 340 are adjusted based on the detected home row finger positions. In response to the detection, at step 1608, a notification may be generated for warning the user about the invalid home row finger position. In examples, the notification may include a visual notification, such as highlighting the affected area of the user-adaptive virtual keyboard UI 300 or displaying a warning message on the screen and/or a haptic feedback 250 or an audio feedback 555. In examples, the notification may continue to be provided to the user until the user adjusts the hand position and re-establishes a home row finger position 390 within the boundaries of the adaptive keyboard home row safe zone 1510 (or until the adaptive keys 340 are no longer narrower than the minimum key width 1520).

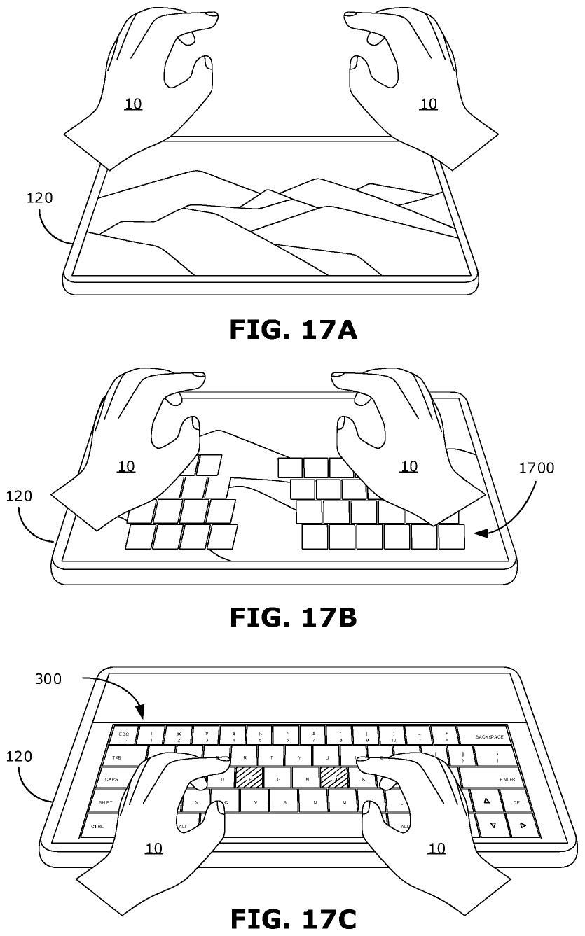

FIGS. 17A-C illustrate an example virtual keyboard preview feature 1700 of the user-adaptive virtual keyboard UI 300, in accordance with examples of the present disclosure. As shown in FIGS. 17A and 17B, the preview feature 1700 may be activated by a hand gesture, for example, when a user's hands hover at a predetermined distance above the touch sensitive display 120. In examples, the preview feature 1700 takes advantage of the capability of capacitive touch screens to sense a user's hands even when they are positioned a short distance away from the screen, for example, a distance of 2 cm or 3 cm away from the screen.

In examples, as shown in FIG. 17A, when the user's hands are far from the touch sensitive display 120, for example, at a distance greater than 3 cm, the user-adaptive virtual keyboard UI 300 is not activated. As shown in FIG. 17B, when a user performs a hover gesture at a predetermined distance (e.g., approximately 2 cm-3 cm) from the touch sensitive display 120, a preview 1700 of the user-adaptive virtual keyboard UI 300 may be displayed. In examples, the preview 1700 may include a visual indication of the size and position of the user-adaptive virtual keyboard UI 300, for example, so that users can visually perceive the size and position of the left-hand panel 320 and right-hand panel 330 before physically touching the screen. This allows them to familiarize themselves with the layout and adjust their hand position accordingly before making contact with the touch sensitive display 120, improving accuracy and efficiency while typing on the user-adaptive virtual keyboard UI 300. In examples, as shown in FIG. 17C, in response to the user's fingers contacting the touch sensitive display 120, the user-adaptive virtual keyboard UI 300 may be fully displayed.

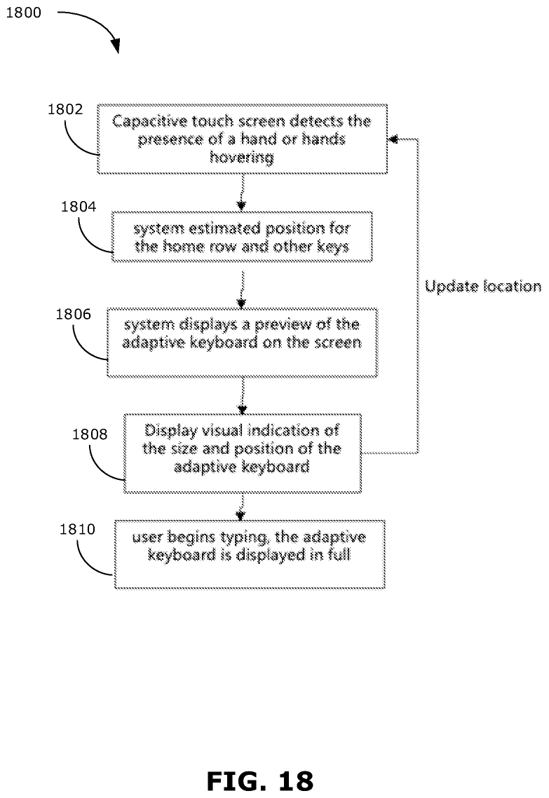

FIG. 18 is a flowchart illustrating an example method 1800 for generating a preview 1700 of the user-adaptive virtual keyboard UI 300 via a hover gesture, in accordance with examples of the present disclosure. The method 1800 may be implemented by the computing system 100 executing instructions of the user-adaptive virtual keyboard module 200 (which may be stored in memory 110), for example. In examples, method 1800 begins at step 1802 in which a sensing module 220 detects, from data sensed by the capacitive touch sensitive display 120, the hover gesture at a predetermined distance above the capacitive touch sensitive display 120. In examples, the computing system 100 may infer a position of a user's hands while performing the hover gesture. In examples, at step 1804, the computing system 100 may estimate a position of home row keys and other keys 310 in the user-adaptive virtual keyboard UI 300, based on the inferred position of the user's hands.

In examples, at step 1806, a preview 1700 of the user-adaptive virtual keyboard UI 300 may be displayed on the touch sensitive display 120. In examples, the preview 1700 may provide an indication, at step 1808, of the size and position of the layout of the user-adaptive virtual keyboard UI 300. In examples, in response to the preview 1700, the user may adjust the position of their hands performing the hover gesture, and the method 1800 may return to step 1802 to update the location of the preview 1700 on the screen. In examples, in response to the user contacting the touch sensitive display 120, the entire user-adaptive virtual keyboard UI 300 may be displayed.

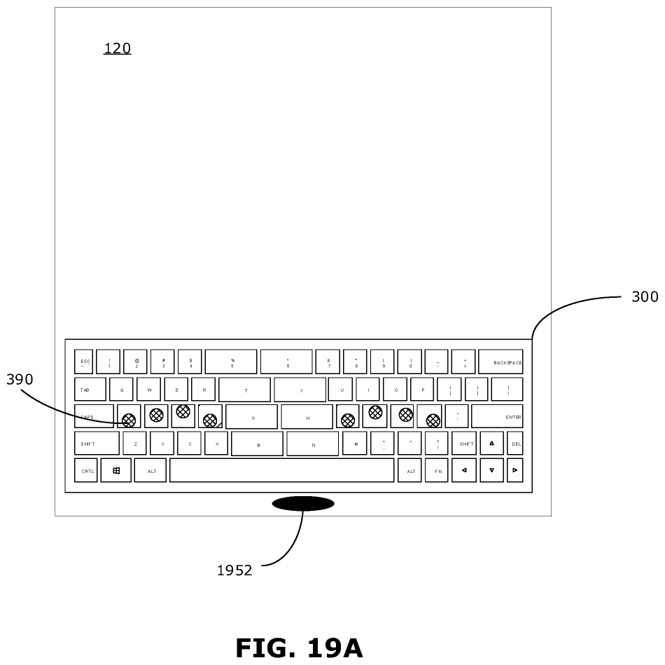

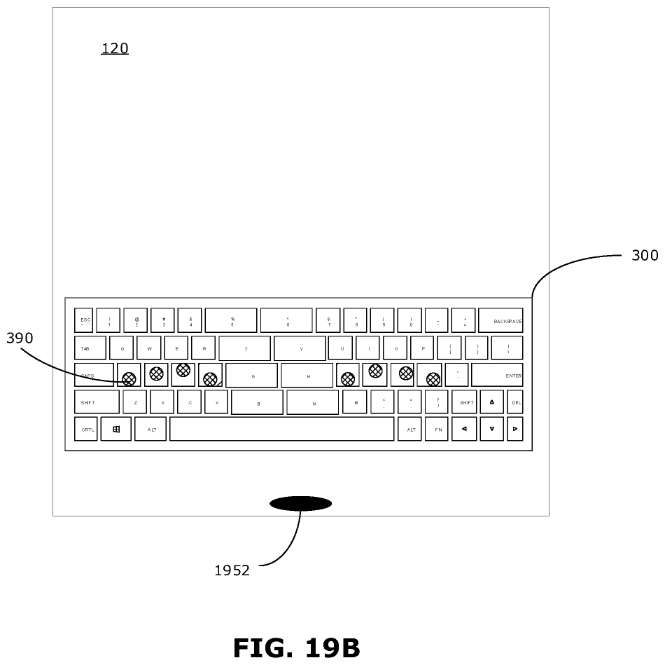

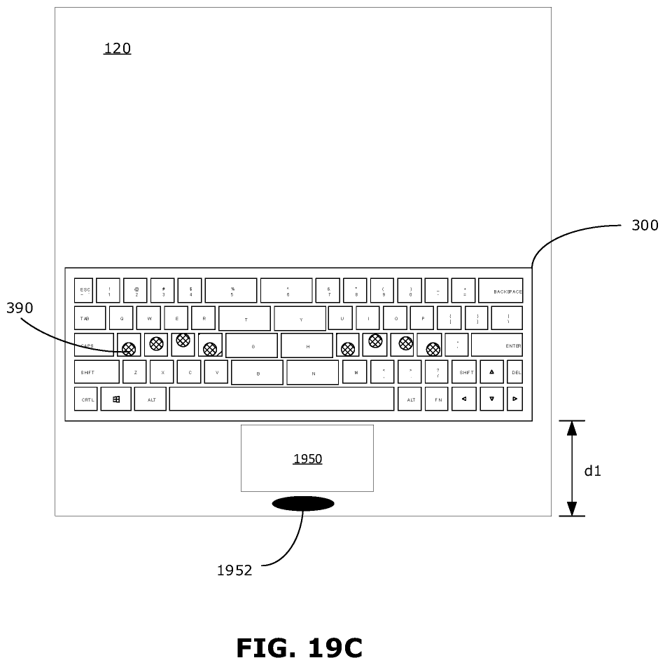

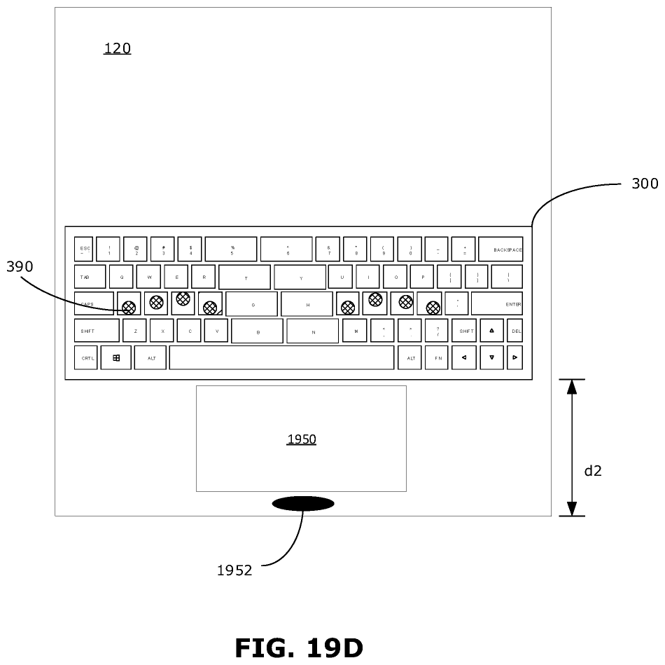

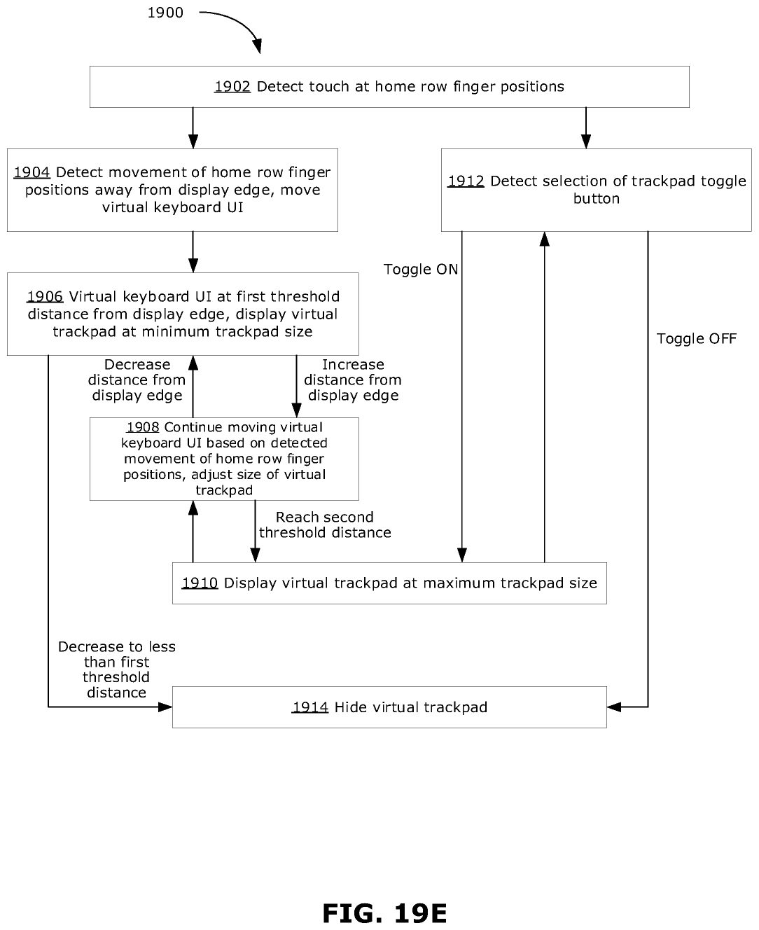

Reference is now made to FIGS. 19A-19D, which illustrate an example of how the user-adaptive virtual keyboard UI 300 may be displayed together with dynamic display of a virtual trackpad 1950. A virtual trackpad may refer to a UI element that functions similar to a touch-based trackpad on a laptop. A user may perform touch gestures in the virtual trackpad 1950, as well a finger tap gestures (which may be interpreted by the computing system as click events). The virtual trackpad 1950 may be displayed dynamically, based on the detected home row finger positions 390. For example, as the user moves their hand positions up or down, the home row finger positions 390 corresponding move up or down and the user-adaptive virtual keyboard UI 300 is similarly moved up or down such that the home row keys of the user-adaptive virtual keyboard UI 300 match the position of the detected home row finger positions 390. The virtual trackpad 1950 may be dynamically displayed and sized based on the distance between the user-adaptive virtual keyboard UI 300 and an edge (e.g., the lower edge) of the touch sensitive display 120.

As shown in FIG. 19A, for example, when the detected home row finger positions 390 are close to the edge of the touch sensitive display 120, the user-adaptive virtual keyboard UI 300 may correspondingly be displayed close to the edge of the touch sensitive display 120. In FIG. 19B, as the detected home row finger positions 390 move away from the display edge, the user-adaptive virtual keyboard UI 300 is also moved such that the distance between the user-adaptive virtual keyboard UI 300 and the display edge is increased. In FIG. 19C, as the detected home row finger positions 390 continue to move and the user-adaptive virtual keyboard UI 300 correspondingly moves away from the display edge, the distance between the user-adaptive virtual keyboard UI 300 and the display edge reaches a first threshold distance, indicated as d1. Accordingly, the virtual trackpad 1950 is displayed, at a minimum trackpad size, in the margin between the user-adaptive virtual keyboard UI 300 and the display edge. As the user-adaptive virtual keyboard UI 300 continues to move away from the display edge, in response to movement of the detected home row finger positions 390, the virtual trackpad 1950 may continue to increase in size (e.g., according to the space available in the margin between the user-adaptive virtual keyboard UI 300 and the display edge). In FIG. 19D, the detected home row finger positions 390 continue to move until the user-adaptive virtual keyboard UI 300 has moved a second threshold distance, indicated as d2, from the display edge. Accordingly, the virtual trackpad 1950 is displayed at a maximum trackpad size. Further movement of the detected home row finger positions 390 away from the display edge (e.g., towards the top of the touch sensitive display 120) may be considered to be movement to an invalid home row position and a notification may be generated (e.g., as described with respect to method 1600 of FIG. 16). It should be understood that the virtual trackpad 1950 may also be dynamically adjusted in reverse, to return back to the minimum trackpad size or to hide the trackpad.

Alternatively or additionally, a virtual toggle button 1952 may be provided close to the edge of the touch sensitive display 120. Detection of a touch event at the virtual toggle button 1952 may toggle display of the virtual trackpad 1950 between display at the maximum trackpad size (e.g., as shown in FIG. 19D) and hiding the trackpad (e.g., as shown in FIG. 19A).

FIG. 19E is a flowchart illustrating an example method 1900 for dynamic display of a virtual trackpad with a virtual keyboard. The method 1000 may be implemented by the computing system 100 executing instructions of the user-adaptive virtual keyboard module 200 (which may be stored in memory 110), for example. In some examples, the method 1900 may be performed when the user-adaptive virtual keyboard UI 300 is in use. By monitoring sensed contact data, touch events may be detected, as previously described. The method 1900 may start at 1902, when touch events are detected at reference finger positions, such as the home row finger positions. The user-adaptive virtual keyboard UI 300 may be displayed at a first distance from the edge of the touch sensitive display 120 based on the location of the home row finger positions.

At 1904, the computing system 100 may detect movement of the home row finger positions 390 away from the edge of the touch sensitive display 120 (e.g., due to the user moving their hands in an upward movement while maintaining contact or near contact with the touch sensitive display 120), and the user-adaptive virtual keyboard UI 300 may be accordingly moved away from the display edge, such that the home row keys of the user-adaptive virtual keyboard UI 300 match the moved home row finger positions 390. At 1906, when the user-adaptive virtual keyboard UI 300 has moved a first threshold distance from the display edge, a virtual trackpad 1950 may be displayed in the margin between the user-adaptive virtual keyboard UI 300 and the display edge. The virtual trackpad 1950 may be displayed at its minimum trackpad size.

As the home row finger positions 390 continue to move away from the display edge, the method 1900 may proceed to step 1908. At 1908, the user-adaptive virtual keyboard UI 300 continues to move based on the detected movement of the home row finger positions 390, such that the distance between the user-adaptive virtual keyboard UI 300 and the display edge increases. The size of the virtual trackpad 1950 may be adjusted based on the distance between the user-adaptive virtual keyboard UI 300 and the display edge, for example the virtual trackpad 1950 may be sized to have a height that fits within the margin between the user-adaptive virtual keyboard UI 300 and the display edge. As the home row finger positions 390 continue to move yet farther away from the display edge, the distance between the user-adaptive virtual keyboard UI 300 and the display edge increases until a second threshold distance is reach. When the second threshold distance is reached, then at 1910 the virtual trackpad 1950 may be displayed at its maximum trackpad size.

Another mechanism for triggering display of the virtual trackpad 1950 at the maximum trackpad size may be a trackpad toggle button 1952, which may be a soft button that is displayed at or near the display edge of the touch sensitive display. At 1912, selection of the trackpad toggle button 1952 may be detected (e.g., a touch event is detected at the location of the trackpad toggle button 1952). If the virtual trackpad 1950 is not already displayed at the maximum trackpad size, selection of the trackpad toggle button 1952 causes the trackpad toggle to be ON and the trackpad is displayed at the maximum trackpad size at 1910. The user-adaptive virtual keyboard UI 300 may be automatically shifted by a distance that is at least the second threshold distance, so that there is sufficient space in the margin between the user-adaptive virtual keyboard UI 300 and the display edge to accommodate the virtual trackpad 1950 at the maximum trackpad size. In some examples, use of the trackpad toggle button 1952 may enable the user to quickly switch between hiding the virtual trackpad 1950 and displaying the virtual trackpad 1950 at the maximum trackpad size. In some examples, the trackpad toggle button 1952 may be selected when the virtual trackpad 1950 is displayed at less than maximum trackpad size, in order to automatically expand the virtual trackpad 1950 to the maximum trackpad size (and automatically shift the user-adaptive virtual keyboard UI 300 as appropriate to accommodate the virtual trackpad 1950 at the maximum trackpad size).

While the trackpad is displayed at the maximum trackpad size at 1910, movement of the home row finger positions 390 may continue to be monitored. If there is detected movement of the home row finger positions 390 back towards the display edge (e.g., due to the user moving their hands in a downward movement while maintaining contact or near contact with the touch sensitive display 120), then the method 1900 may return to 1908 where the user-adaptive virtual keyboard UI 300 is moved to match the detected movement of the home row finger positions 390. This causes the distance between the user-adaptive virtual keyboard UI 300 and the display edge to decrease, and the size of the virtual trackpad 1950 may correspondingly decrease to fit within the decreased margin between the user-adaptive virtual keyboard UI 300 and the display edge. From 1908, if the home row finger positions 390 again move away from the display edge to reach the second threshold distance, the method 1900 may return to 1910. Alternatively, from 1908, if the home row finger positions 390 continue to move towards the display edge to decrease the distance between the user-adaptive virtual keyboard UI 300 and the display edge, the size of the virtual trackpad 1950 may continue to decrease until reaching the minimum trackpad size at 1906. When the virtual trackpad 1950 is displayed at the minimum trackpad size, if the home row finger positions 390 continue to move towards the display edge such that the distance between the user-adaptive virtual keyboard UI 300 becomes less than the first threshold distance, then at 1914 the virtual trackpad 1950 may be hidden and no longer displayed by the touch sensitive display 120.

Returning to 1910, another mechanism for hiding the virtual trackpad 1950 may be the trackpad toggle button 1952. If the virtual trackpad 1950 is displayed (e.g., at maximum trackpad size) and selection of the trackpad toggle button 1952 is detected at 1912 (e.g., a touch event is detected at the location of the trackpad toggle button 1952), then the trackpad toggle becomes OFF and the virtual trackpad 1950 may be hidden at 1914 and no longer displayed by the touch sensitive display 120.

The example mechanisms for dynamic display of a virtual trackpad, as described above with respect to FIGS. 19A-19E, enable the dynamic display of the virtual trackpad based on the user's hand resting position (on the home row finger positions). This provides a technical solution by providing a convenient user interface in which the user can have a comfortable position using the virtual keyboard at certain distance from the display edge, with their hands resting at their preferred location on the touch sensitive display. These examples may also provide greater flexibility in display of the UI on the touch sensitive display, which may enable more efficient user of the area available on the touch sensitive display for displaying UI elements. The dynamic display of the virtual trackpad enables the virtual trackpad to be displayed only when desired and to be hidden when not being used, so that the display area may be used more efficiently.

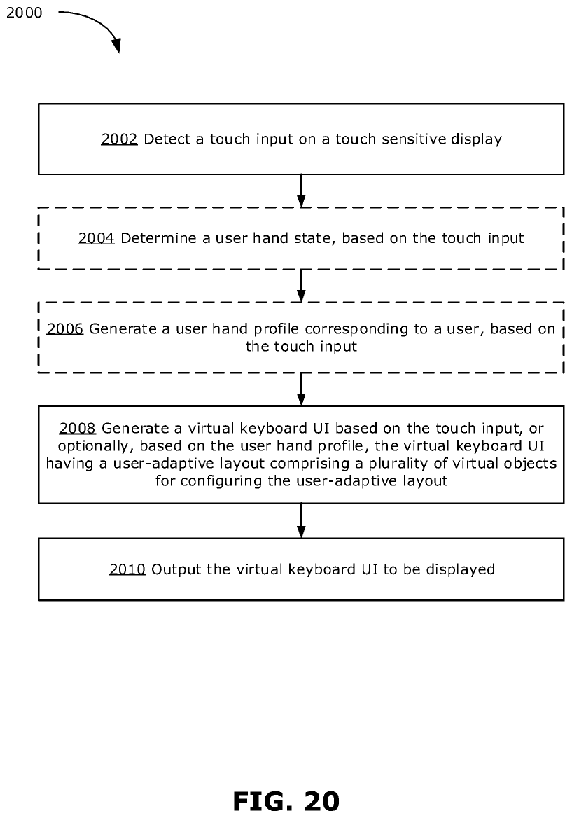

FIG. 20 is a flowchart illustrating an example method 2000 for generating a user-adaptive virtual keyboard UI 300 for output to a display, in accordance with examples of the present disclosure. The method 2000 may be performed by the computing system 100. For example, the processor 102 may execute computer readable instructions (which may be stored in the memory 110) to cause the computing system 100 to perform the method 2000. The method 2000 may be performed using a single physical machine (e.g., an electronic device, a workstation or server), a plurality of physical machines working together (e.g., a server cluster), or cloud-based resources (e.g., using virtual resources on a cloud computing platform).

Method 2000 begins with step 2002, in which a touch input 510 is detected on a touch sensitive surface 120. In examples, the touch input corresponds to contact with the touch sensitive surface 120 by a user's hand 10.

Optionally, at step 2004, a user hand state may be determined, based on the touch input 510. For example, the user hand state may be representative of a “ready state”, for example, where the user's fingers are resting and/or positioned in a home row posture over the virtual keys associated with the home row on the user-adaptive virtual keyboard UI 300. In other examples, the user hand state may represent an accidental touch by the user.

Optionally, at step 2006, a user hand profile 540 may be generated for a user, based on the touch input 510. In examples, information about a user's hand size, (such as palm size, finger length, finger span, or other measurements, etc.) may be measured or inferred, based on the touch input, for example, during an onboarding process. In examples, the user hand profile 540 may then be generated based on the hand measurements.

In examples, at step 2008, a virtual keyboard user interface (UI) 300 may be generated based on the touch input 510, or optionally, based on the user hand profile 540 (as described with respect to step 2006). In examples, the virtual keyboard UI 300 may include a user-adaptive layout comprising a plurality of virtual objects for configuring the user-adaptive layout. In examples, the virtual objects may include a plurality of adaptive virtual keys 340, a left-hand panel 320 of virtual keys and a right-hand panel 330 of virtual keys.

In examples, at step 2010, the user-adaptive virtual keyboard UI 300 may be output to a display 130, where the displayed virtual keyboard UI 300 is customized to the user's needs or preferences.

Examples of the present disclosure have been described in the context of typing on a virtual keyboard on a touch screen enabled device, including, for example, foldable PC/tablets, e-ink readers, traditional single-screen computers, laptops or tablets, and dual-screen electronic devices, among others, as an input method for typing on the touch screen enabled device or for serving as an input device (e.g., a wireless keyboard) for another electronic device. Although examples have been described in the context of typing on a virtual keyboard on a touch screen enabled device, it should be understood that the present disclosure is not limited to interactions with a GUI environment on a touch screen enabled device. For example, the touch input may also be representative of a mid-air gesture, for example, a captured by an external camera tracking system or computer vision system, for interacting with a user-adaptive virtual keyboard 200 in an AR/VR environment, among others.

Various embodiments of the present disclosure having been thus described in detail by way of example, it will be apparent to those skilled in the art that variations and modifications may be made without departing from the disclosure. The disclosure includes all such variations and modifications as fall within the scope of the appended claims.

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein. The machine-executable instructions may be in the form of code sequences, configuration in-formation, or other data, which, when executed, cause a machine (e.g., a processor or other processing device) to perform steps in a method according to examples of the present disclosure.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

1. A computer-implemented method comprising:
detecting a touch input on a touch sensitive display;
generating a virtual keyboard user interface (UI) based on the touch input, the virtual keyboard UI comprising a plurality of virtual objects arranged in a user-adaptive layout based on the touch input; and
outputting the virtual keyboard UI to be displayed on the touch sensitive display, according to the user-adaptive layout.

2. The method of claim 1, wherein the plurality of virtual objects includes a plurality of adaptive virtual keys, each of the plurality of adaptive virtual keys having a respective one or more properties for dynamically configuring the user-adaptive layout, and wherein generating the virtual keyboard UI comprises:
adjusting the respective one or more properties of each of the plurality of adaptive virtual keys, based on the touch input.

3. The method of claim 2, wherein the one or more properties includes at least one of:
key size;
key pitch;
key gap; or
key aspect ratio.

4. The method of claim 2, wherein the plurality of virtual objects also includes a first panel of virtual keys and a second panel of virtual keys, wherein each of the plurality of virtual adaptive keys are configured in the user-adaptive layout to be adjacent to one or both of the first panel of virtual keys and the second panel of virtual keys, and wherein outputting the virtual keyboard UI to be displayed comprises:
outputting the first panel of virtual keys, the second panel of virtual keys and the plurality of adaptive keys to be displayed, according to the user-adaptive layout.

5. The method of claim 1, wherein detecting the touch input comprises:
detecting touch input at locations representative of home row finger positions defined in the virtual keyboard UI.

6. The method of claim 1, further comprising:
prior to detecting the touch input:
detecting a virtual keyboard launch gesture in proximity to the touch sensitive display;
detecting a hand position in proximity to the touch sensitive display, based on the virtual keyboard launch gesture; and
configuring a preview of the virtual keyboard UI to be displayed on the touch sensitive display, based on the hand position.

7. A computer-implemented method comprising:
performing a virtual keyboard calibration by:
detecting touch input on a touch sensitive display, the touch input being detected as sensor data representative of a placement of a palm and fingers of a hand on the touch sensitive display; and
obtaining one or more measurements of the hand, based on the sensor data;
generating a virtual keyboard user interface (UI) comprising a plurality of virtual objects arranged in a user-adaptive layout based on the one or more measurements of the hand obtained by performing the virtual keyboard calibration; and
outputting the virtual keyboard UI to be displayed on the touch sensitive display, according to the user-adaptive layout.

8. The method of claim 7, wherein a user hand profile is generated based on the one or more measurements of the hand.

9. The method of claim 8, wherein the user hand profile is stored and wherein the user-adaptive layout of the virtual keyboard UI is stored in association with the user hand profile.

10. The method of claim 9, wherein generating the virtual keyboard UI comprises determining that the user hand profile matches an existing stored user hand profile, and retrieving the stored user-adaptive layout associated with the stored user hand profile to use for the generating the virtual keyboard UI.

11. The method of claim 7, further comprising:
prior to performing the virtual keyboard calibration, detecting a virtual keyboard launch gesture in proximity to the touch sensitive display; and
performing the virtual keyboard calibration responsive to detecting the virtual keyboard launch gesture.

12. The method of claim 7, wherein the plurality of virtual objects includes a plurality of adaptive virtual keys, each of the plurality of adaptive virtual keys having a respective one or more properties for dynamically configuring the user-adaptive layout, and wherein generating the virtual keyboard UI comprises:
adjusting the respective one or more properties of each of the plurality of adaptive virtual keys, based on the one or more hand measurements.

13. The method of claim 12, wherein at least one property of each of the plurality of adaptive virtual keys is at least one of:
key size;
key pitch;
key gap; or
key aspect ratio.

14. A computer-implemented method comprising:
detecting a touch input on a touch sensitive display, the touch input representing home row finger positions defined for a virtual keyboard user interface (UI);
outputting the virtual keyboard UI to be displayed on the touch sensitive display, the virtual keyboard UI being displayed at a location on the touch sensitive display corresponding to the touch input representing the home row finger positions;
in response to detecting touch input representing movement of the home row finger positions away from the edge of the touch sensitive display, move the virtual keyboard UI to increase a margin between the virtual keyboard UI and an edge of the touch sensitive display;
wherein a virtual trackpad is displayable in the margin between the virtual keyboard UI and the edge of the touch sensitive display.

15. The method of claim 14, wherein a size of the virtual trackpad increases as the margin between the virtual keyboard UI and the edge of the touch sensitive display increases, and the size of the virtual trackpad decreases as the margin between the virtual keyboard UI and the edge of the touch sensitive display decreases.

16. The method of claim 14, wherein the virtual trackpad is displayed in the margin between the virtual keyboard UI and the edge of the touch sensitive display in response to the virtual keyboard UI being moved a first threshold distance from the edge of the touch sensitive display.

17. The method of claim 16, wherein the virtual trackpad is displayed in the margin between the virtual keyboard UI and the edge of the touch sensitive display at a maximum trackpad size in response to the virtual keyboard UI being moved a second threshold distance, greater than the first threshold distance, from the edge of the touch sensitive display.

18. The method of claim 14, further comprising:
detecting a touch input representing selection of a trackpad toggle button displayed on the touch sensitive display;
responsive to selection of the trackpad toggle button, moving the virtual keyboard UI to increase the margin between the virtual keyboard UI and the edge of the touch sensitive display to accommodate display of the virtual trackpad; and
displaying the virtual trackpad in the margin between the virtual keyboard UI and the edge of the touch sensitive display.

19. The method of claim 18, wherein, responsive to selection of the trackpad toggle button, the virtual keyboard UI is moved to increase the margin between the virtual keyboard UI and the edge of the touch sensitive display to accommodate display of the virtual trackpad at a maximum trackpad size.

20. The method of claim 18, further comprising:
while the virtual trackpad is displayed, detecting a touch input representing another selection of the trackpad toggle button;
responsive to selection of the trackpad toggle button, moving the virtual keyboard UI to decrease the margin between the virtual keyboard UI and the edge of the touch sensitive display; and
hiding the virtual trackpad from being displayed.
